(19) United States
(12) Patent Application Publication
(10) Pub. No.: US 2023/0023041 A1
(43) Pub. Date: Jan. 26, 2023

(54) RADIO LINK MONITORING

(71) Applicant: Ofinno, LLC, Reston, VA (US)

(72) Inventors: Yunjung Yi, Vienna, VA (US); Esmael Hejazi Dinan, McLean, VA (US); Ali Cagatay Cirk, Chantilly, VA (US); Hyukjin Chae, San Diego, CA (US); Bing Hui, Herndon, VA (US); Hua Zhou, Vienna, VA (US)

(73) Assignee: Ofinno, LLC, Reston, VA (US)

(21) Appl. No.: 17/960,987

(22) Filed: Oct. 6, 2022

Related U.S. Application Data
(63) Continuation of application No. PCT/US2021/026227, filed on Apr. 7, 2021.
(60) Provisional application No. 63/007,239, filed on Apr. 8, 2020.

(51) Int. Cl. H04W 72/12; H04W 24/08; H04W 24/10; H04L 5/00

(52) U.S. Cl. CPC H04W 72/1273; H04W 24/08; H04W 24/10; H04L 5/0051

(57) ABSTRACT

A wireless device receives configuration parameters of a primary cell and a secondary cell. In response to the secondary cell cross-carrier scheduling the primary cell, the wireless device determines radio link monitoring reference signals based on: one or more first control resource sets (coresets) of the primary cell and one or more second coresets of the secondary cell. The wireless device measures the radio link monitoring reference signals for radio link monitoring of the primary cell.

### CROSS-REFERENCE TO RELATED APPLICATIONS

This application is a continuation of International Application No. PCT/US2021/026227, filed Apr. 7, 2021, which claims the benefit of U.S. Provisional Application No. 63/007,239, filed Apr. 8, 2020, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an example of implicit RLM-RS determination as per an aspect example embodiment of the present disclosure.

FIG. 18 illustrates an example of a radio link failure detection as per an aspect example embodiment of the present disclosure.

FIG. 19 illustrates an example of stopping a timer for a radio link monitoring as per an aspect example embodiment of the present disclosure.

FIG. 20 illustrates an example of a beam failure detection procedure as per an aspect example embodiment of the present disclosure.

FIG. 21 illustrates an example flowchart of a beam failure recovery process as per an aspect example embodiment of the present disclosure.

FIG. 22 illustrates an example of mixed cross-carrier and self-carrier scheduling for a first cell as per an aspect example embodiment of the present disclosure.

FIG. 23 illustrates an example of a multi-carrier scheduling as per an aspect example embodiment of the present disclosure.

FIG. 24 illustrates an example of configuration parameters as per an aspect example embodiment of the present disclosure.

FIG. 25 illustrates an example of configuration parameters as per an aspect example embodiment of the present disclosure.

FIG. 26 illustrates an example diagram of a radio link monitoring process as per an aspect example embodiment of the present disclosure.

FIG. 27 illustrates an example embodiment as per an aspect example embodiment of the present disclosure.

FIG. 28 illustrates an example embodiment as per an aspect example embodiment of the present disclosure.

FIG. 29 illustrates an example embodiment as per an aspect example embodiment of the present disclosure.

FIG. 30 illustrates an example diagram of a radio link monitoring process as per an aspect example embodiment of the present disclosure.

FIG. 31 illustrates an example diagram of a radio link monitoring process as per an aspect example embodiment of the present disclosure.

FIG. 32 illustrates an example flowchart as per an aspect example embodiment of the present disclosure.

FIG. 33 illustrates an example flowchart as per an aspect example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

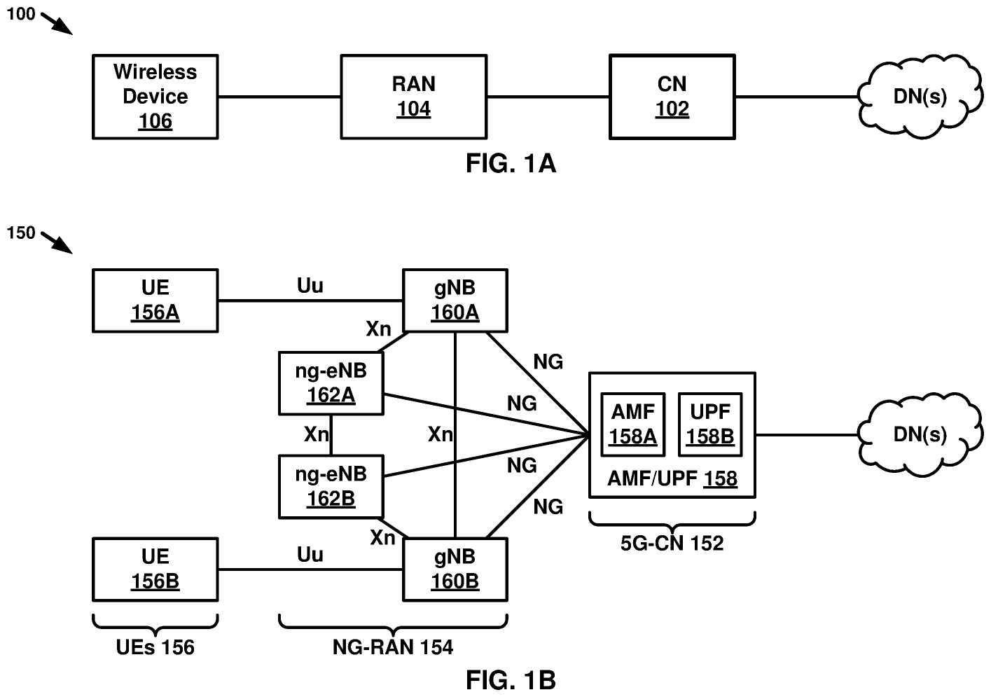

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible.

For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNB s 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

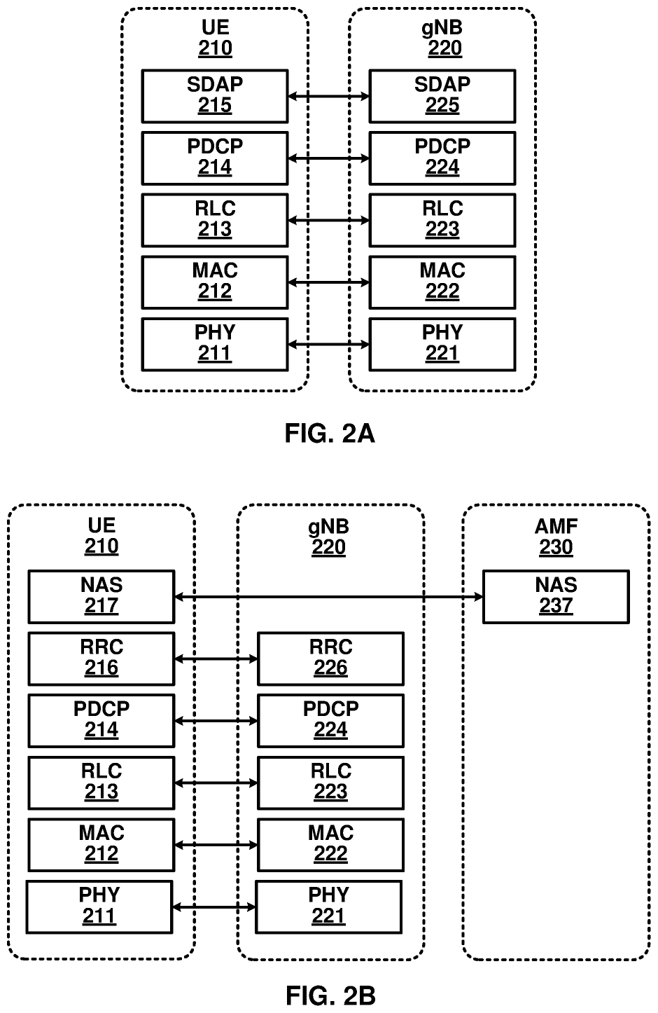

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

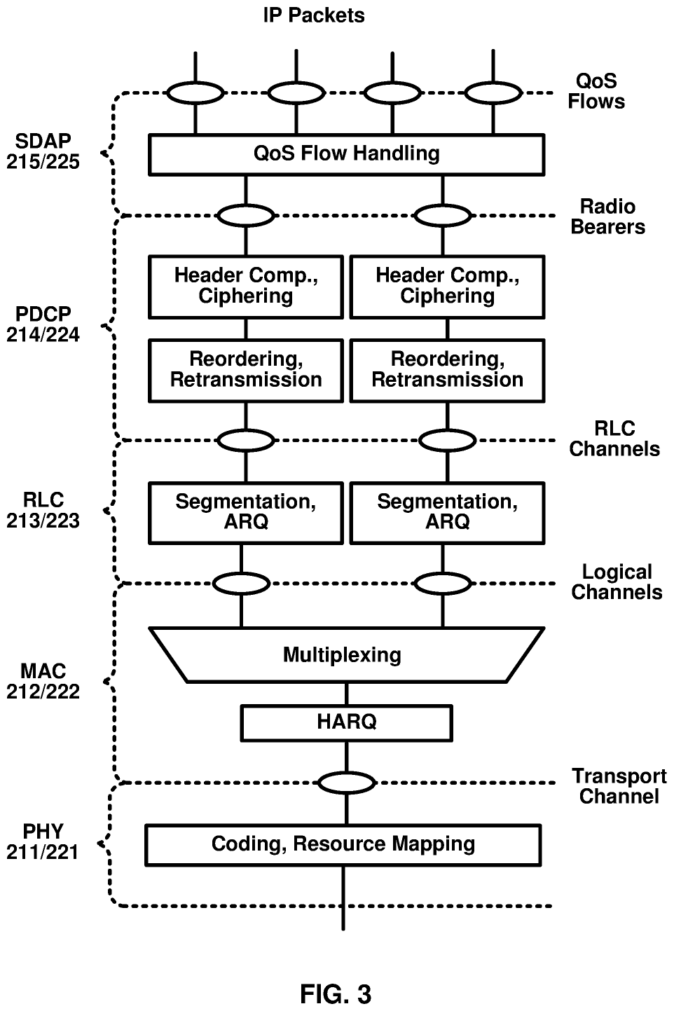

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

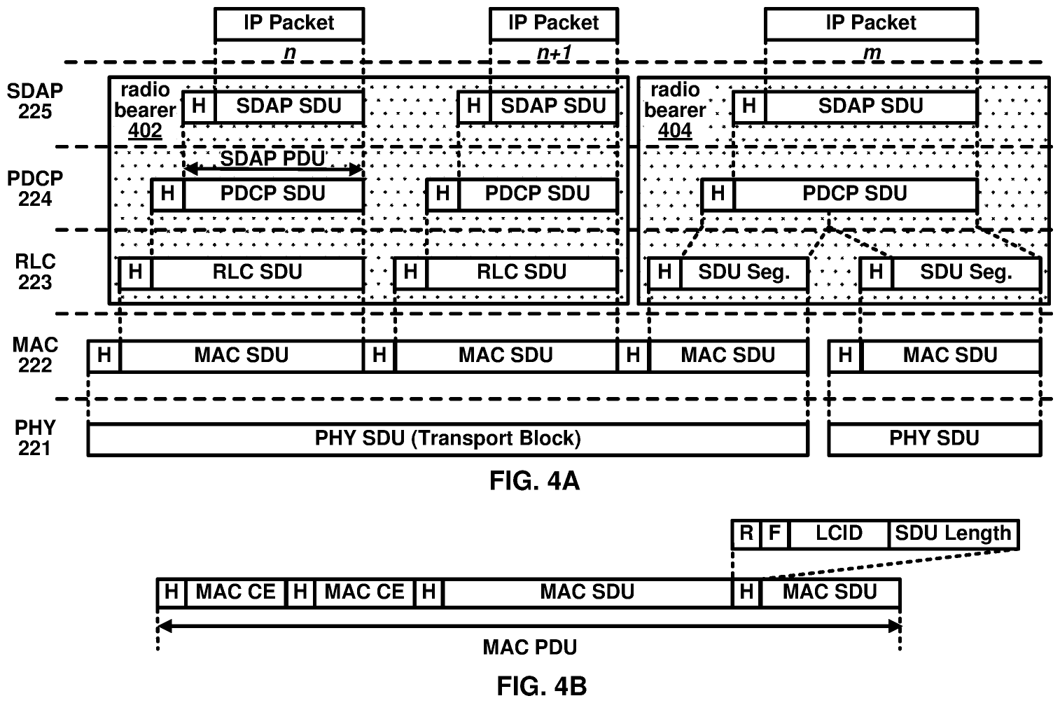

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

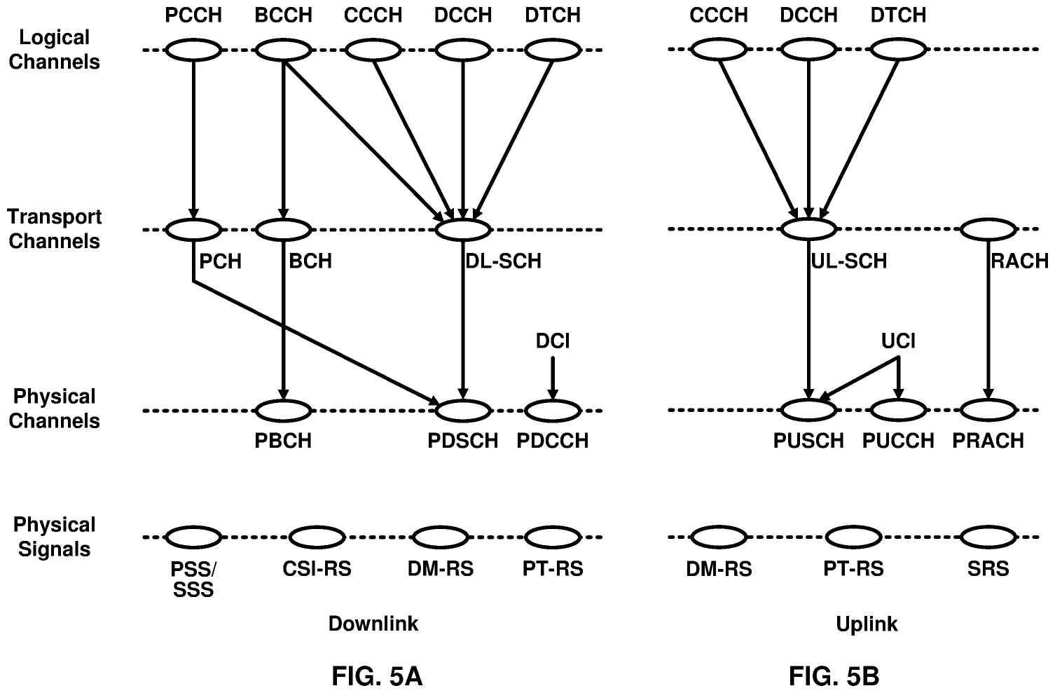

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs
to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

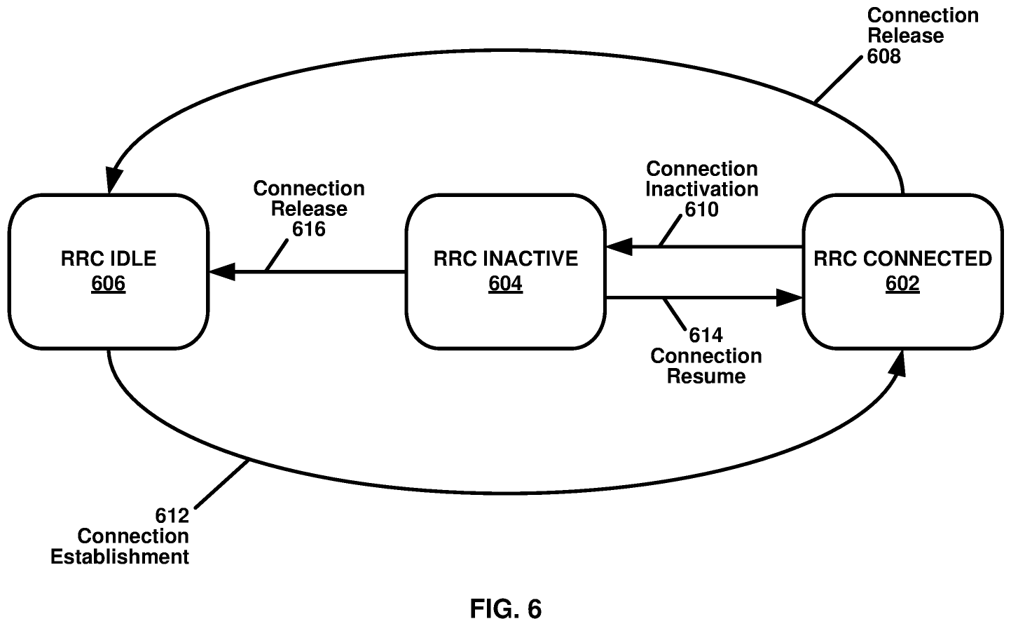

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

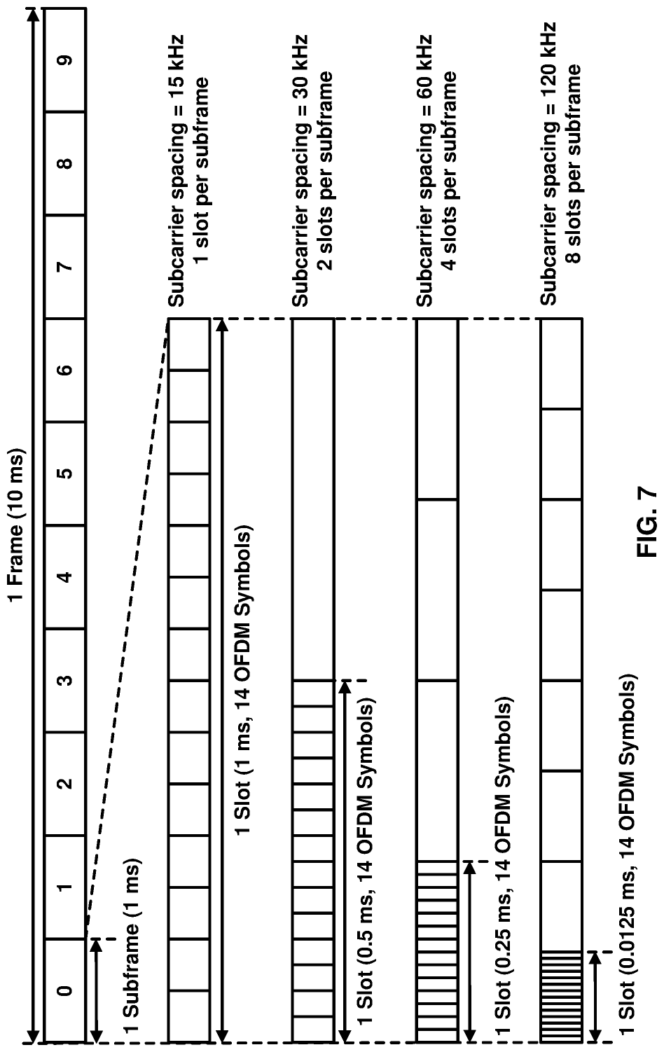

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

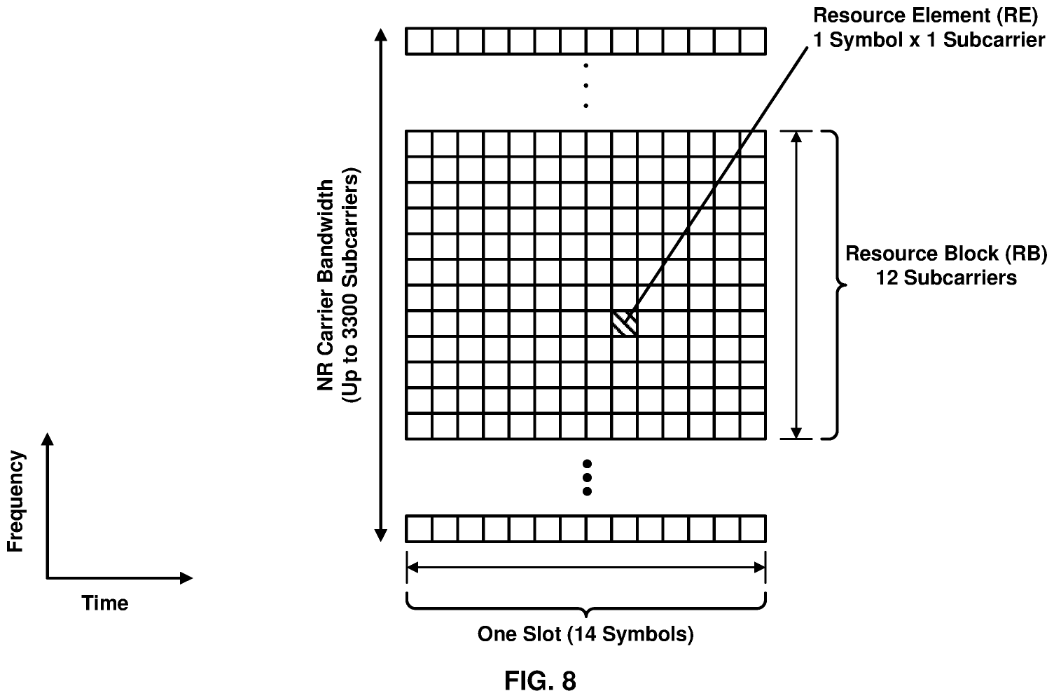

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

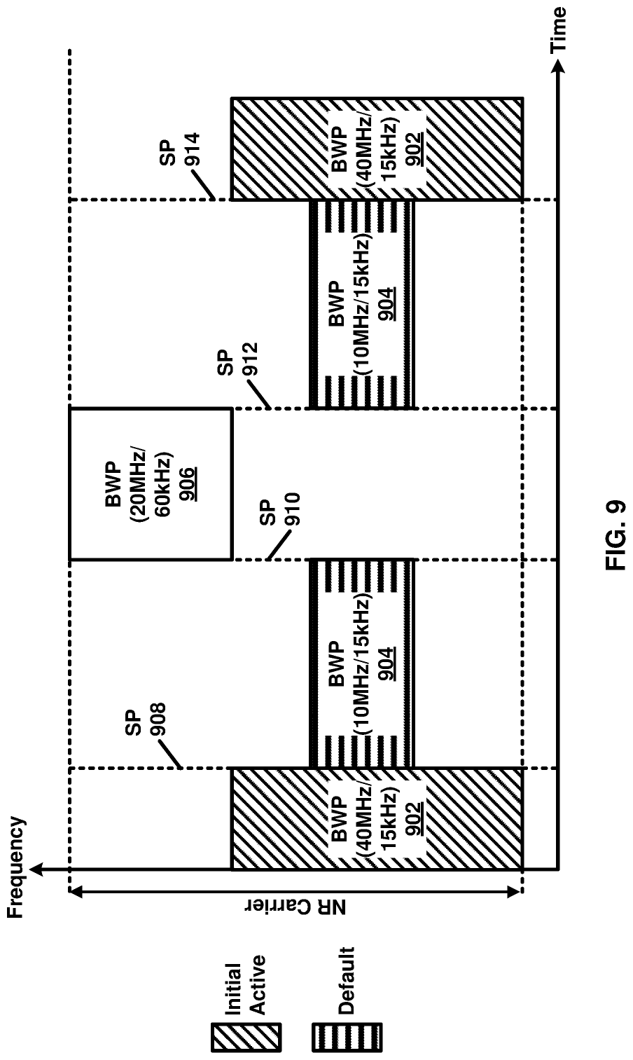

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

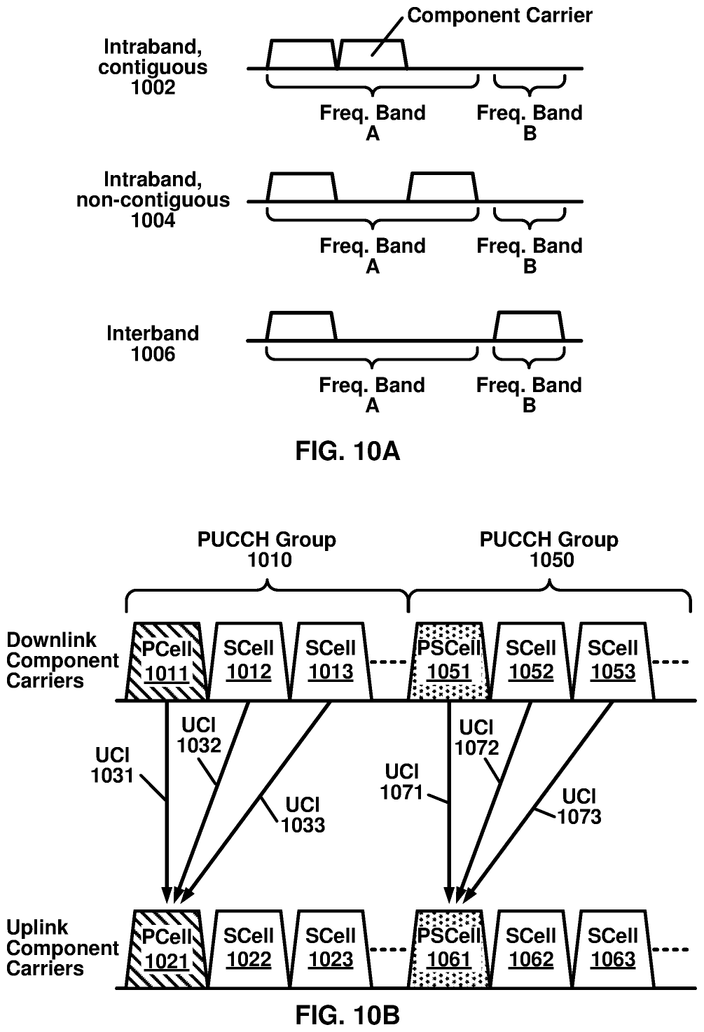

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

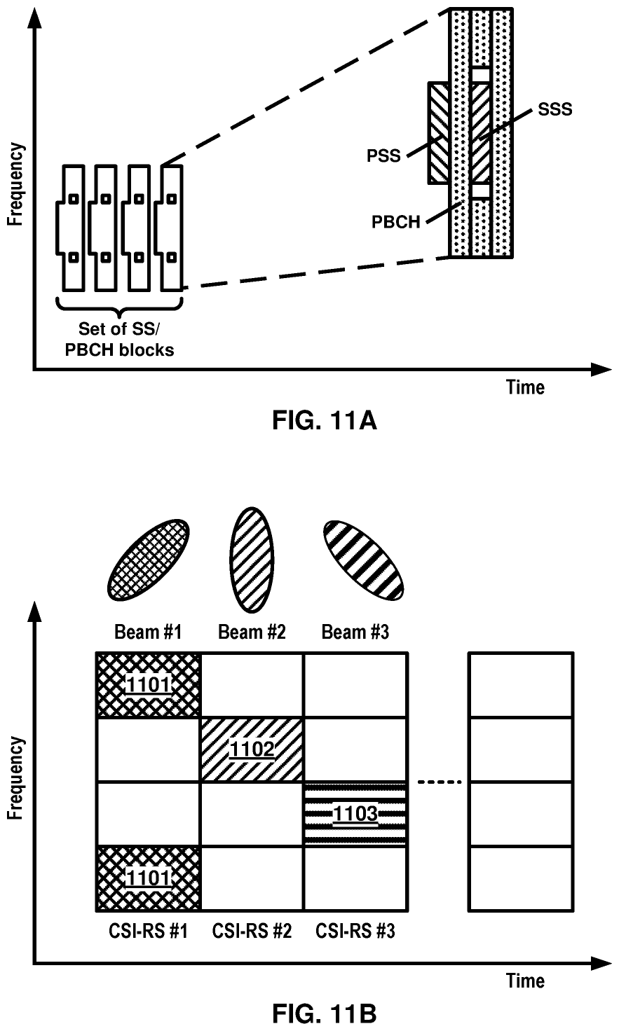

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

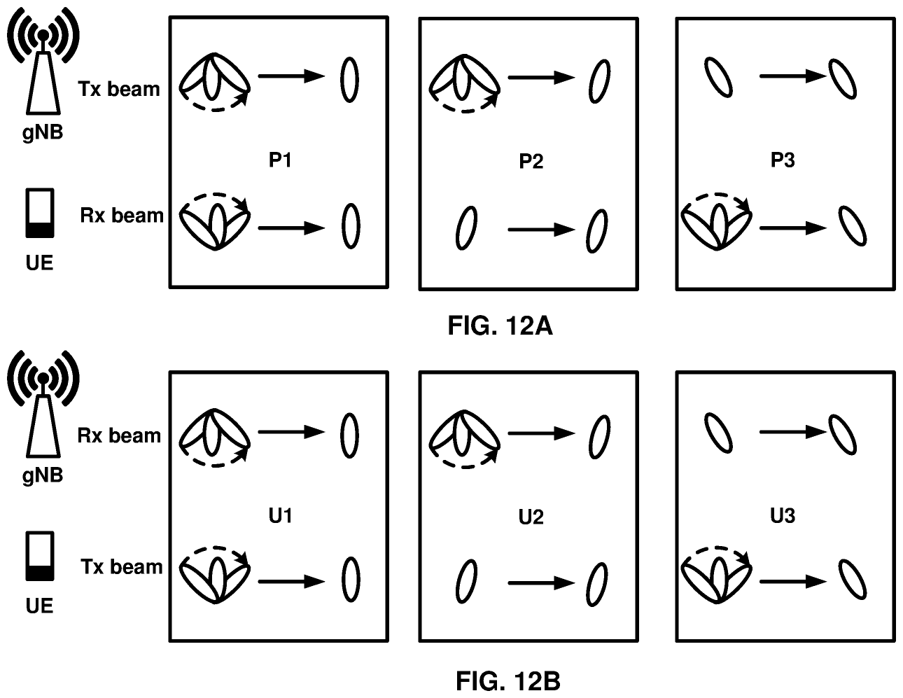

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

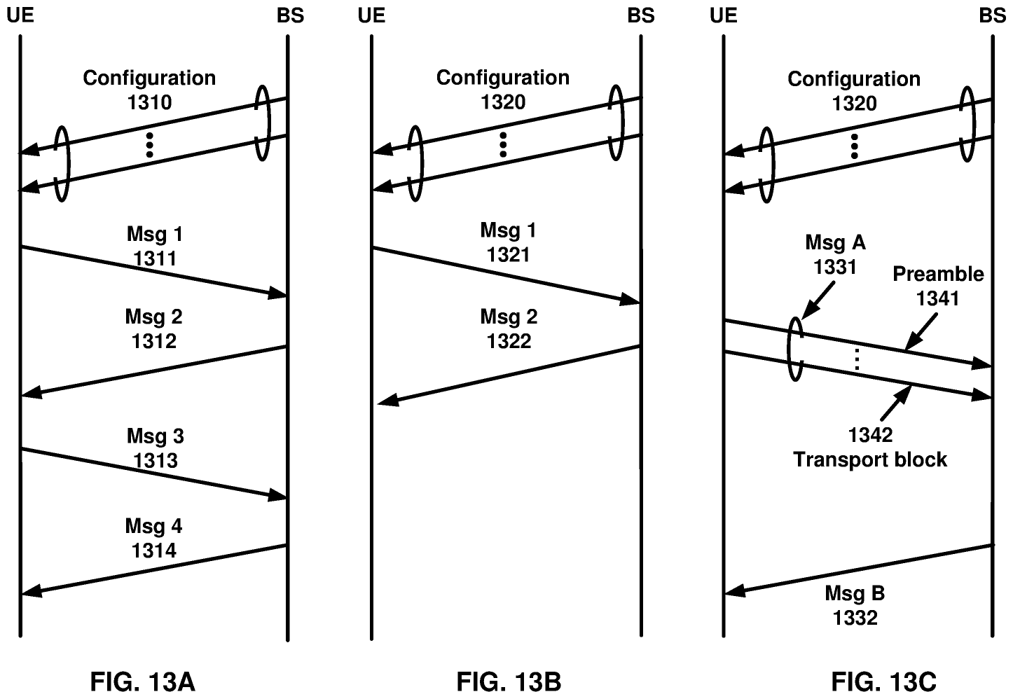

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id where s_id may be an index of a first OFDM symbol of the PRACH occasion (e.g., 0≤s_id<14), t_id may be an index of a first slot of the PRACH occasion in a system frame (e.g., 0≤t_id<80), fid may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

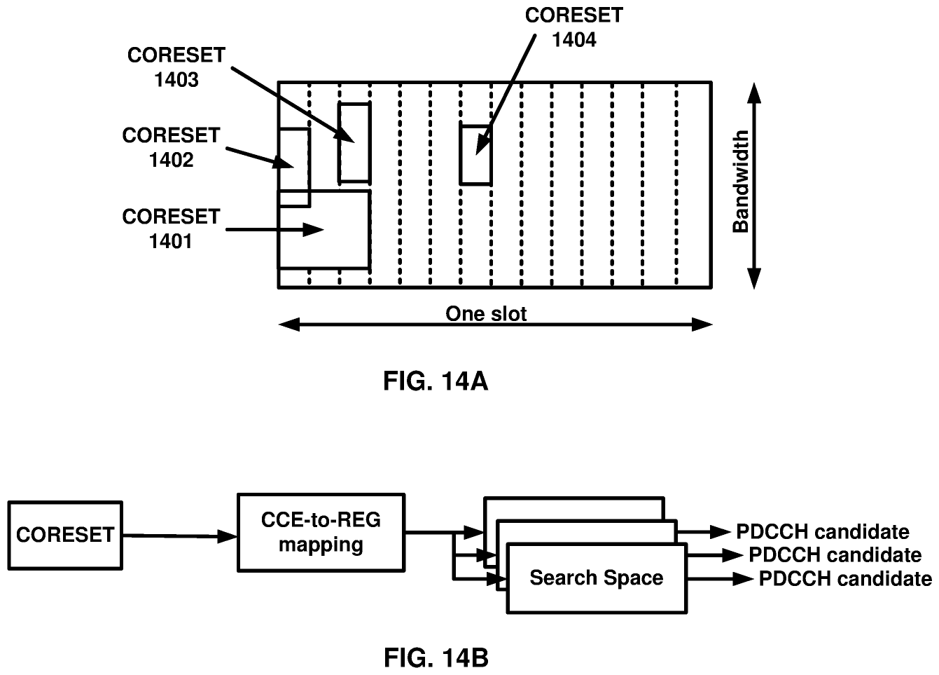

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g., a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

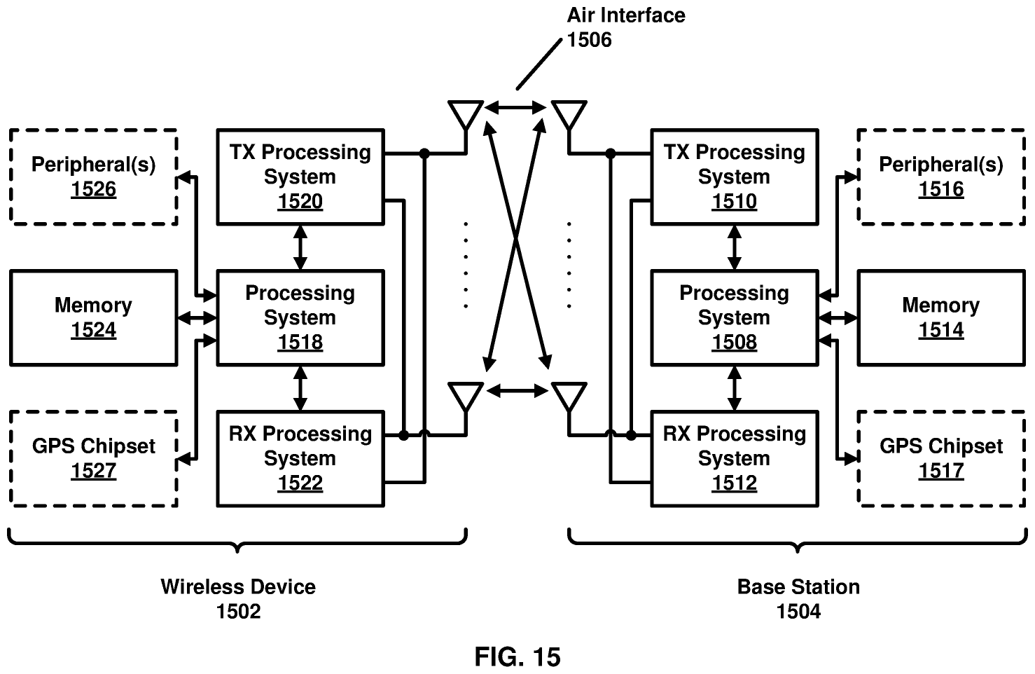

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

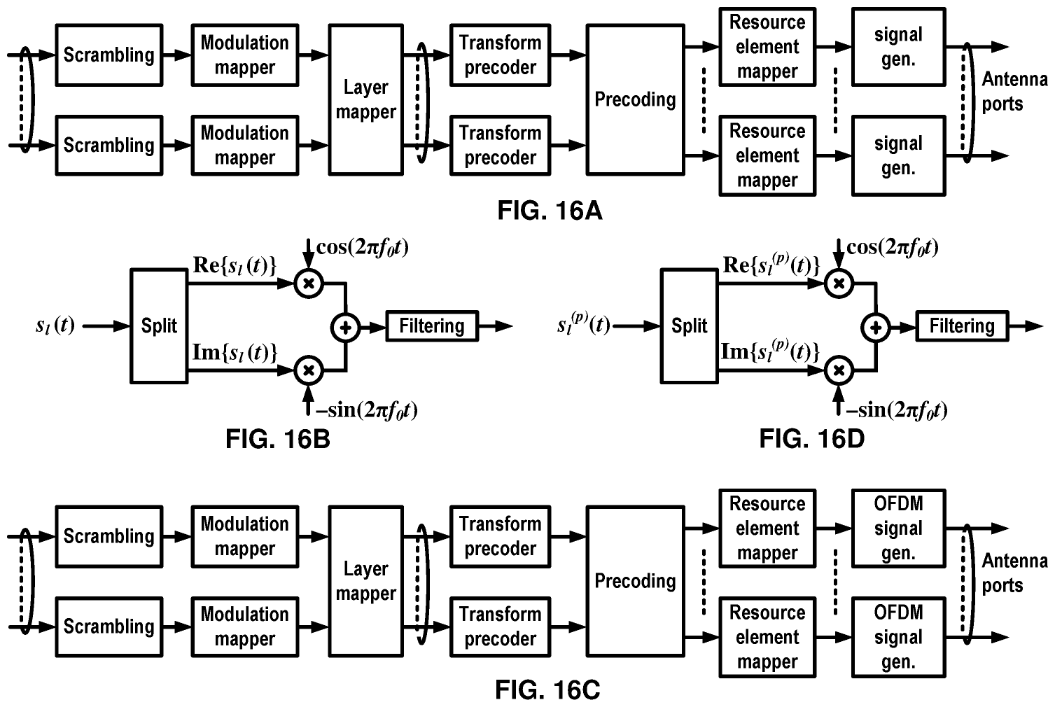

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual-connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

In an example, a wireless device may perform a radio link monitoring (RLM) measurements in an active BWP of a primary cell based on one or more reference signals such as SSB (synchronization signal and PBCH block) and/or CSI-RS. The wireless device may measure signal qualities of the one or more reference signals and compare the measured signal qualities with one or more signal quality thresholds configured by a base station. The base station may configure one or more SSBs as the reference signals for a case where an initial downlink BWP of the primary cell is the active BWP of the primary cell, and the initial downlink BWP comprises the one or more SSBs. The base station may configure one or more SSBs and/or CSI-RSs as the reference signals for non-initial DL BWPs. The wireless device may declare a radio link failure (RLF) if one or more conditions are met. For example, the one or more conditions may comprise a case where a timer (e.g., T310) expires wherein the timer may have started after the wireless device may indicate N310 times of out-of-sync events to its higher layer (e.g., radio resource control layer). For example, the one or more conditions may comprise a case where a random access procedure is failed after attempting a configured number of retransmissions/retrials. For example, the one or more conditions may comprise a case where the wireless device may detect/determine a radio link control (RLC) failure.

The wireless device may determine/declare the RLF. In response to the RLF, the wireless device may stay in an RRC_CONNECTED state while identifying a suitable cell to perform a handover. If a suitable cell cannot be identified (e.g., within a period of time after RLF declaration), the wireless device may switch to an RRC_IDLE state. The period of time may be marked by a second timer.

A wireless device may measure downlink radio link qualities of a primary cell in order to identify out-of-sync/in-sync events/status. The wireless device may indicate out-of-sync/in-sync events/status to the wireless device's higher layer (e.g., RRC layer). The wireless device may monitor/perform the measurements in an active downlink BWP of the primary cell. Inactive downlink BWPs of the primary cell may not be monitored. The wireless device may perform the measurements based on one or more SSB (SS/PBCH) blocks (e.g., SSBs received via the active downlink BWP of the primary cell). The wireless device may perform radio link monitoring for a primary cell of a master cell group (PCell) and/or a primary cell of a secondary cell group (SPCell).

In an example, a base station may configure one or more radio link monitoring reference signals (which may be referred to as RLM-RS or RadioLinkMonitoringRS). The RLM-RS may be configured as failure detection resources (failureDetectionResources). The RLM-RS and/or failure detection resources may be configured with an index (e.g., RadioLinkMonitoringRS-Id). The RLM-RS and/or failure detection resources may comprise channel state information reference signals (CSI-RS) and/or SS/PBCH blocks (SSB). The CSI-RS may be configured based on a CSI-RS identifier (csi-RS-Index). The SS/PBCH block may be configured based on an SS/PBCH block identifier (ssb-Index). The base station may configure the RLM-RS for the purpose of beam failure detection, radio link failure detection, or both. The wireless device may use the RLM-RS for the purpose configured by the base station. An RLM-RS configured for the purpose of radio link failure detection or the purpose of both the beam failure detection and the radio link failure detection may be called as a failureDetectionResource. An RLM-RS configured for the purpose of a beam failure detection or the purpose of both the beam failure detection and the radio link failure detection may be called as a detectionResource or a detectionRS. RLM-RS may refer to a failureDetectionResource unless otherwise noted. The base station may configure up to N RLM-RS and/or failure detection resources. The base station may configure up to K failure detection resources from the N RLM-RS. The wireless device may use up to two RSs from the N configured RLM-RS for performing beam failure detection, radio link failure detection, or both.

In an example, a wireless device may support a set of {N, K} based on a number of candidate SSBs in an initial BWP of a primary cell. For example, when the number of candidate SSBs is 4, the wireless device may support {2, 2} for the {N, K} (e.g., N=2 and K=2). For example, when the number of candidate SSBs is 8, the wireless device may support {6, 4} for the {N, K} (e.g., N=6 and K=4). For example, when the number of candidate SSBs is 64, the wireless device may support {8, 8} for the {N, K} (e.g., N=8 and K=8).

In an example, a base station may not configure RLM-RS to a wireless device for a primary cell. In response to an absence of configured RLM-RS, the wireless device may determine one or more reference signals (e.g., CSI-RSs) based on one or more control resource sets (CORESETs) configured/associated with an active BWP of the primary cell. For example, the wireless device may determine a CSI-RS included in a transmission configuration indicator (TCI) state of a CORESET of the one or more CORESETs. The wireless device may determine an RS included in the TCI state when the TCI state comprises a single RS as the CSI-RS. The wireless device may determine an RS included in the TCI state when the TCI state comprises two RSs, wherein the RS is configured with QCL-TypeD (e.g., a spatial domain related quasi-collocated property), as the CSI-RS. The wireless device may use the CSI-RS associated with the CORESET as an RLM-RS.

In some examples, the wireless device may determine up to N CSI-RSs for the RLM-RSs, where N is determined based on the number of candidate SSBs. The wireless device may determine the N CSI-RSs based on one or more CORESETs of an active downlink BWP of the primary cell. The wireless device may determine up to K failure detection resources based on active TCI states associated with one or more second CORESETs. When a number of the one or more CORESETs is smaller than or equal to K, the wireless device may select, as the RLM-RSs, CSI-RSs associated with active TCI states of the one or more CORESETs. The wireless device may select the one or more second CORESETs from the one or more CORESETs, wherein the one or more second CORESETs are associated/configured with search spaces with shorter monitoring periodicities. The wireless device may select a CORESET with a search space with a shortest monitoring periodicity first, and select a next CORESET with a second search space with a next shortest monitoring periodicity, and so on. The wireless device may select the one or more second CORESETs based on ascending order of search spaces monitoring periodicity associated with the one or more CORESETs.

In an example, the base station may configure the wireless device with one or more CORESETs for the downlink BWP. In an example, the base station may configure a CORESET of the one or more coresets with at least two TCI states (e.g., by a first higher layer parameter tci-StatesPDCCH-ToAddList and/or a second higher layer parameter tci-StatesPDCCH-ToReleaseList). In an example, the wireless device may receive an activation command (e.g., a MAC CE activation command) indicating/activating a TCI state of the at least two TCI states for the coreset. In an example, the (activated or active) TCI state may comprise/indicate an RS index (e.g., csi-RS-Index, ssb-index) indicating an RS (e.g., CSI-RS). Based on the receiving the activation command indicating/activating the TCI state, the wireless device may monitor for a DCI in the CORESET based on the RS indicated by the (activated or active) TCI state. Based on the receiving the activation command indicating/activating the TCI state, the wireless device may assume that one or more DMRS antenna ports for a PDCCH reception in the CORESET is quasi co-located with the RS indicated in the TCI state. The wireless device may use the RS associated with the TCI state to determine one or more radio/channel properties such as average delay, delay spread, spatial RX parameter, doppler shift, and/or doppler spread of the DM-RS associated with the CORESET.

In an example, the base station may configure a CORESET of the one or more CORESETs with a TCI state (e.g., by a first higher layer parameter tci-StatesPDCCH-ToAddList and/or a second higher layer parameter tci-StatesPDCCH-ToReleaseList). In an example, based on being configured with the TCI state, the wireless device may not monitor for an activation command (e.g., a MAC CE activation command) for the CORESET. In an example, based on being configured with the TCI state, the wireless device may activate the TCI state for the CORESET. In an example, the (activated or active) TCI state may comprise/indicate an RS index (e.g., csi-RS-Index, ssb-index) indicating an RS (e.g., CSI-RS). The wireless device may monitor for a DCI in the CORESET based on the RS indicated by the (activated or active) TCI state. The wireless device may assume that one or more DMRS antenna ports for a PDCCH reception in the CORESET is quasi co-located with the RS.

In an example, the base station may not configure, by a higher layer parameter (e.g., failureDetectionResource), the downlink BWP of the cell with a set of resource indexes (e.g., through RadioLinkMonitoringRS) for a link monitoring. In an example, the base station may configure, for PDCCH receptions, one or more TCI states (e.g., by a first higher layer parameter tci-StatesPDCCH-ToAddList and/or a second higher layer parameter tci-StatesPDCCH-ToReleaseList) for the one or more coresets of the downlink BWP. In an example, the one or more TCI states may comprise/indicate one or more RSs (e.g., CSI-RSs). In an example, the wireless device may use, for the link monitoring, RS(s) indicated/provided/included in active TCI state(s) of the one or more TCI states. In an example, the RS(s) may have a QCL type(s) (e.g., QCL-TypeD). For example, QCL-TypeD may define reusing/utilizing a spatial Rx parameter of the RS(s) of the TCI state in receiving DM-RS(s) of a control and/or a data. In an example, the RS(s) may be periodic. In an example, the RS(s) may be aperiodic. In an example, the RS(s) may be semi-persistent. In an example, the one or more CORESETs of the downlink BWP may comprise a first CORESET and a second CORESET. In an example, the wireless device may receive, for the first CORESET, a first activation command (e.g., MAC CE activation command) indicating/activating a first TCI state of the one or more TCI states. The first TCI state may indicate a first RS of the one or more RSs. In an example, the wireless device may receive a second activation command indicating/activating a second TCI state of the one or more TCI states. The second TCI state may indicate a second RS of the one or more RSs. The first RS may have a QCL-TypeD. The second RS may have a QCL-TypeD. In an example, the wireless device may, for the link monitoring, use/select the first RS indicated by the first (active) TCI state and the second RS indicated by the second (active) TCI state.

In an example, the base station may not configure, by a higher layer parameter (e.g., failureDetectionResource), the downlink BWP of the cell with a set of resource indexes (e.g., through RadioLinkMonitoringRS) for a link monitoring. In an example, the base station may configure, for PDCCH receptions, one or more TCI states (e.g., by a first higher layer parameter tci-StatesPDCCH-ToAddList and/or a second higher layer parameter tci-StatesPDCCH-ToReleaseList) for the one or more coresets of the downlink BWP. In an example, a maximum number of SS/PBCH blocks transmitted per half frame may be a first number. In an example, the first number may be four (e.g., L_max=4). In an example, the first number may be eight (e.g., L_max=8). In an example, the first number may be sixty-four (e.g., L_max=64). In an example, a number of the one or more coresets may be greater than the maximum RS number. In an example, the one or more coresets of the downlink BWP may comprise a first coreset, a second coreset, and a third coreset (the number of the one or more coresets is equal to three). In an example, the maximum RS number may be two. In an example, a number of CORESETs in the one or more CORESETs may be greater than the maximum RS number. In an example, the one or more coresets of the downlink BWP may comprise a first coreset, a second coreset, and a third CORESET (the number of coresets in the one or more coresets is equal to three). In an example, the maximum RS number may be two. Based on the number of CORESETs in the one or more coresets being greater than the maximum RS number, the wireless device may apply an RS selection rule for the link monitoring. In an example, the wireless device may select, in the RS selection rule for the link monitoring, RS(s) indicated by active TCI state(s) of the one or more TCI states. In an example, the selecting the RSs may comprise selecting the RSs indicated by the active TCI state(s) of CORESETs, of the one or more CORESETs, associated with (or linked to) search space sets in an order from a shortest monitoring periodicity. In an example, the selecting the RSs may comprise selecting the RSs indicated by the active TCI state(s) of coresets, of the one or more coresets, identified by, in an order from, a highest coreset-specific index. In an example, a number of the RS(s) may be equal to less than the maximum RS number. In an example, a number of RSs in the RS(s) may be equal to less than the maximum RS number. The wireless device may support up to K RS(s) associated with K TCI states of K CORESETs. The K may be smaller than or equal to the maximum RS number.

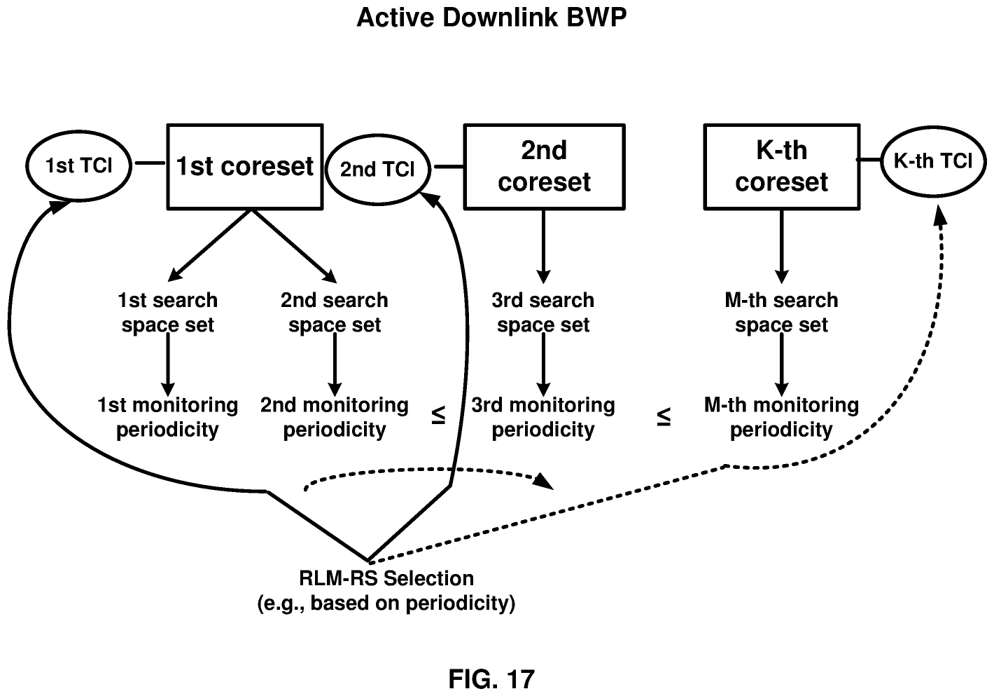

FIG. 17 illustrates an example of determining K RLM-RSs based on one or more CORESETs of an active BWP of a primary cell. For example, the wireless device is configured with a first CORESET (first coreset), a second coreset and a k-th coreset. Each coreset is configured/activated with a TCI state. For example, a first TCI state is an active TCI state of the first coreset. A second TCI state is an active TCI state of the second coreset. For example, a k-th TCI state is an active TCI state of the k-th coreset. Each active TCI state may be configured with a single reference signal or two reference signals. The wireless device may determine a RS from the single or two reference signals based on a QCL type-D association. The RS of each TCI state may be selected as an RLM-RS. For example, a candidate number of SSBs is 4, where N is 2 and K is 2. The wireless device may select up to 2 RLM-RSs from the configured coresets of the active BWP of the primary cell. In the example, the wireless device may order one or more search spaces associated with the configured coresets based on a monitoring periodicity. When a coreset is associated with a plurality of search spaces, a smallest monitoring periodicity is selected. For example, the wireless device is configured with the first search space and the second search space in FIG. 17. The wireless device may select the second search space, wherein the second monitoring periodicity is smaller than the first monitoring periodicity of the first search space as an monitoring periodicity for the first coreset. The wireless device may order the configured search spaces based on a smallest monitoring periodicity associated with each coreset and may select up to K RLM-RSs based on active TCI states of the selected coresets. In FIG. 17, the wireless device selects a first RS of the first TCI state and a second RS of the second TCI state for two RLM-RSs. When the wireless device may select more than two, the wireless device may continue selecting other RSs.

In an example, the first RS and the second RS may be the same. The wireless device may select a third RS of the k-th TCI as a second RLM-RS. The wireless device may select up to K distinct RLM-RSs based on active TCI states of the configured coresets.

In an example, a wireless device may determine up to two RSs (e.g., detectionRS) for link quality monitoring to identify a beam failure of a cell based on one or more configured CORESTEs of an active BWP of the cell. The wireless device may determine a periodic CSI-RS associated with an active TCI state of a CORESET of the one or more configured CORESETs as a detectionRS. The wireless device may select up to two periodic CSI-RSs associated with the active TCI states of the one or more configured CORESETs. For example, in FIG. 17, the wireless device may select the first RS of the first TCI state and the third RS of the k-th TCI state, in response to the RS associated with the second TCI is being an SSB.

For example, a RS is associated with a TCI state, wherein the RS is configured as a reference signal of a qcl-Type1 or qcl-Type2 of the TCI state. The reference signal may indicate a csi-rs-Index or a ssb-Index depending on the reference signal is based on either a CSI-RS or an SSB. A qcl-Type for the qcl-Type1 or the qcl-Type2 may be one of typeA, typeB, typeC and typeD. The wireless device, if configured with both the qcl-type1 and qcl-type2 for the TCI state, may select a RS of either the qcl-Type1 or the qcl-Type2 based on which parameter comprises typeD as a qcl-Type. For example, if the qcl-Type 1 comprises the typeD as the qcl-Type, the wireless device select a RS associated with the qcl-Type1 for the detectionRS or for the failureDetectionResource. For example, if the qcl-Type 2 comprises the typeD as the qcl-Type, the wireless device select a RS associated with the qcl-Type2 for the detectionRS or for the failureDetectionResource.

In an example, a wireless device may perform measurements of radio link quality based on one or more failureDetectionResources (RLM-RSs) for a radio link monitoring for a cell. The wireless device may measure/access once per a period, whether a weighted average value of the radio link quality may exceed a first threshold (e.g., Qin) or below a second threshold (e.g., Qout), wherein the first threshold and the second threshold may be configured as rlmInSyncOutofSyncThreshold. For example, the wireless device may determine the period based on a larger value between a shortest periodicity of a RLM-RS of the one or more RLM-RSs and X msec (e.g., X=10), wherein the wireless device is not configured with a DRX configuration for the cell. The wireless device may determine the period based on a larger value between the shortest periodicity of the RLM-RS of the one or more RLM-RSs and a DRX periodicity, wherein the wireless device is configured with a DRX configuration for the cell.

In an example, the wireless device may indicate, in radio frames, where the radio link quality is measured/assessed, an out-of-sync to the wireless device's higher layer (e.g., RRC layer), wherein the link qualities of the all one or more RLM-RSs are worse than the second threshold (e.g., Qout). The wireless device may indicate, in the radio frames, where the radio link quality is measured/assessed, an in-sync to the wireless device's higher layer (e.g., RRC layer), wherein link qualities of at least one RLM-RS from the one or more RLM-RSs are better than the first threshold (e.g., Qin).

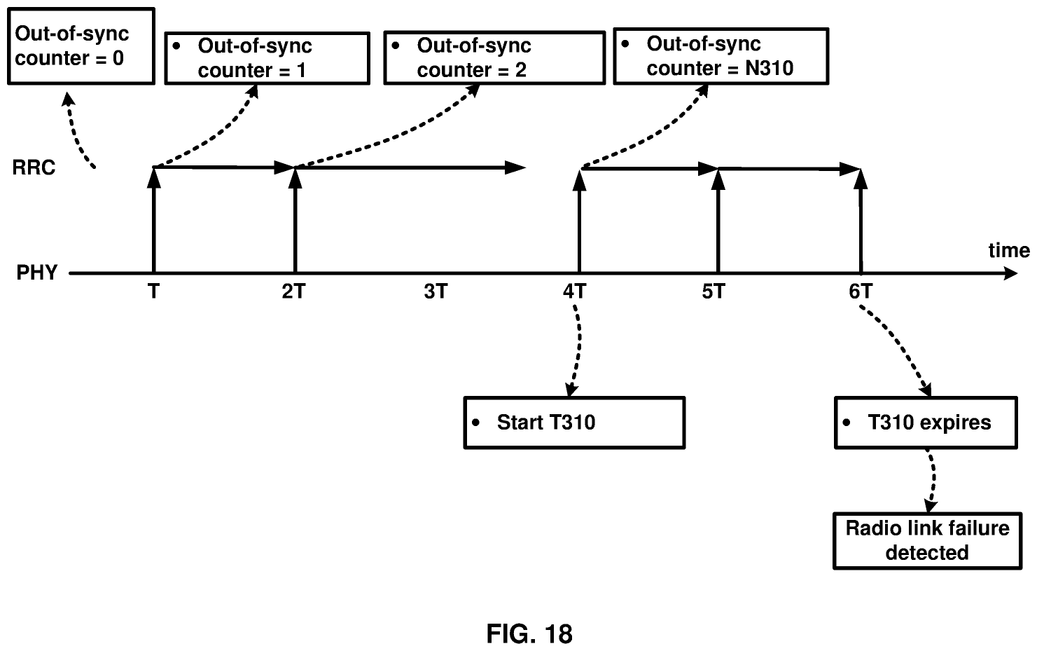

FIG. 18 illustrates an example of a radio link failure declaration/detection. A wireless device may be configured with a counter value (e.g., referred to as N310) for identifying radio link quality failure. The wireless device may set an out-of-sync counter as zero. A lower layer of the wireless device (e.g., PHY as shown in FIG. 18) may determine an out-of-sync event based on a radio link monitoring. The PHY may indicate the out-of-sync event to a higher layer of the wireless device (e.g., RRC as shown in FIG. 18). When the indication is received, the wireless device may increment the out-of-sync counter by one. For example, as shown in FIG. 18, the wireless device increments the out-of-sync counter to one at time every T (e.g., T=10 msec) and two at time 2T based on consecutive indications from a lower layer based on the radio link monitoring/measurement. In the example, the out-of-sync counter reaches the configured counter value (e.g., N310) at time 4T. Accordingly, the wireless device may start a timer (e.g., referred to as T310) at time 4T. If the timer expires (e.g., if the timer does not reset as discussed in greater detail below), the wireless device may declare/detect the RLF.

In response to the RLF, the wireless device may attempt to identify a suitable cell for a hand-over. The wireless device may transition to a RRC IDLE state in response to failure of identify the suitable cell in a time duration after the declaring/detecting the RLF.

In response to receiving an in-sync event/indication from the lower layer, the wireless device may reset the out-of-sync counter (e.g., N310 counter). The wireless device may increment the out-of-sync counter (e.g., N310 counter) only when the first timer (T310) is not running. Otherwise, the wireless device may not increment the out-of-sync counter. The wireless device may reset the out-of-sync counter (e.g., N310 counter) in a new RRC connection via RRCReconfiguration and/or RRC re-establishment procedure.

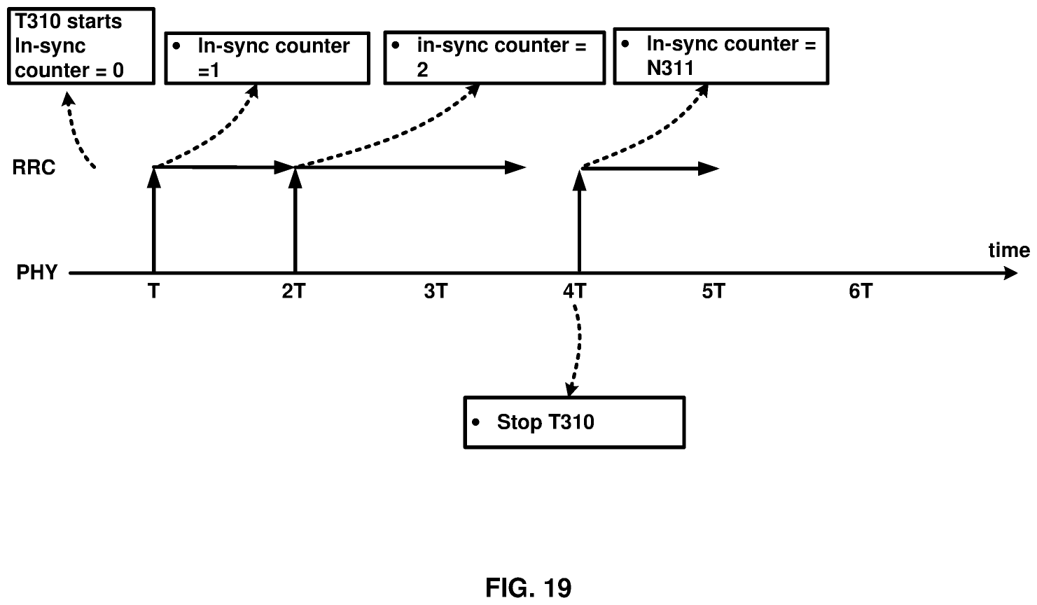

FIG. 19 illustrates an example of cancelling the first timer based on in-sync event(s). In response to the starting of the first timer (e.g., T310), the wireless device may set the in-sync counter (e.g., N311 counter) as zero. The wireless device may increment the in-sync counter in response to receiving an in-sync event from the lower layer. When the in-sync counter reaches a second counter (e.g., N311) or a second threshold, the wireless device may stop the first timer. For example, the in-sync counter becomes N311 at a time of 4T in FIG. 19. The wireless device stops T310 timer (the first timer) so that the wireless device may not declare a RLF.

The wireless device may reset the in-sync counter in response to receiving an out-of-sync even from the lower layer. The wireless device may reset the in-of-sync counter (e.g., N311 counter) in a new RRC connection via RRCReconfiguration and/or RRC re-establishment procedure.

In an example, a base station may configure a wireless device with one or more first reference signals (e.g., beam recovery RSs, SS/PBCH (e.g., SSB) block, CSI-RS, etc.) for beam failure detection. In an example, the wireless device may declare/detect a beam failure based on the one or more first reference signals (RSs) when a number of beam failure instance indications from a physical layer of the wireless device to a higher layer (e.g., MAC layer) of the wireless device reaches a configured threshold (e.g., beam failure instance max count, beamFailureInstanceMaxCount) before an expiry of a configured timer (e.g., beamFailureDetectionTimer).

In an example, an SSB (e.g., cell-defining SSB), that is indicated as a beam recovery reference signal, may be associated with an initial downlink BWP of a cell. In an example, when a current active BWP of a cell is the initial downlink BWP of the cell, the wireless device may perform a beam measurement based on the SSB that the wireless device has identified through an initial access or through a RACH procedure. In an example, the base station may configure the SSB, for detecting the beam failure, for the initial downlink BWP. In an example, the gNB may configure one or more SSBs for beam recovery RSs of a first downlink BWP when the first downlink BWP may include a frequency region of the one or more SSBs and a numerology of the downlink BWP is same as a numerology of the one or more SSBs.

In an example, a gNB may configure one or more CSI-RSs for beam recovery RSs of a second downlink BWP. The second downlink BWP may be same or may be different as the first downlink BWP. The one or more first RSs may comprise one or more CSI-RSs and/or one or more SSBs.

In an example, a wireless device may trigger a beam failure recovery by initiating a random-access procedure on a primary cell, at least when there is a single active TRP on the primary cell from a UE perspective, based on detecting a beam failure. In an example, a wireless device may select a suitable/candidate beam, by performing measurements on one or more candidate beams or candidate beam RSs, for a beam failure recovery based on detecting a beam failure. In an example, the wireless device may determine that the beam failure recovery is completed when the wireless device is completed the RACH procedure.

In an example, a wireless device may perform a beam management and/or a beam failure recovery (BFR) procedure when a base station may enable the BFR procedure, for a UE MAC entity, for a cell. When a wireless device is enabled with a BFR procedure, the wireless device may perform measurements on one or more beam recovery RSs (e.g., first RSs consisting of SSBs and/or CSI-RSs). In response to a beam failure detection, the wireless device may perform measurements on one or more new candidate beam candidate RSs to identify a new candidate beam for a beam failure recovery. In an example, the wireless device may detect the beam failure based on counting a beam failure instance indication from a lower layer of the wireless device (e.g., PHY layer) to the MAC entity.

In an example, a base station may reconfigure an information element (IE) beamFailureRecoveryConfig during an ongoing random-access procedure for a beam failure recovery. In response to the reconfiguring the IE beamFailureRecoveryConfig, the MAC entity may stop the ongoing random-access procedure. Based on the stopping the ongoing random-access procedure, the wireless device may initiate a second random-access procedure for the beam failure recovery using/with the reconfigured IE beamFailureRecoveryConfig.

In an example, an RRC may configure a wireless device with one or more parameters in an IE BeamFailureRecoveryConfig and an IE RadioLinkMonitoringConfig for a beam failure detection and recovery procedure. The one or more parameters may comprise at least: beamFailureInstanceMaxCount for a beam failure detection; beamFailureDetectionTimer for the beam failure detection; beamFailureRecoveryTimer for a beam failure recovery; rsrp-ThresholdSSB: an RSRP threshold for the beam failure recovery; PowerRampingStep for the beam failure recovery; powerRampingStepHighPriority for the beam failure recovery; preambleReceivedTargetPower for the beam failure recovery; preambleTransMax for the beam failure recovery; scalingFactorBI for the beam failure recovery; ssb-perRACH-Occasion for the beam failure recovery; ra-OccasionList for the beam failure recovery; ra-ssb-OccasionMaskIndex for the beam failure recovery; prach-ConfigurationIndex for the beam failure recovery; and ra-ResponseWindow. The ra-ResponseWindow may be a time window to monitor at least one response (e.g., random-access response, BFR response) for the beam failure recovery. In an example, the wireless device may use a contention-free random-access preamble for the beam failure recovery.

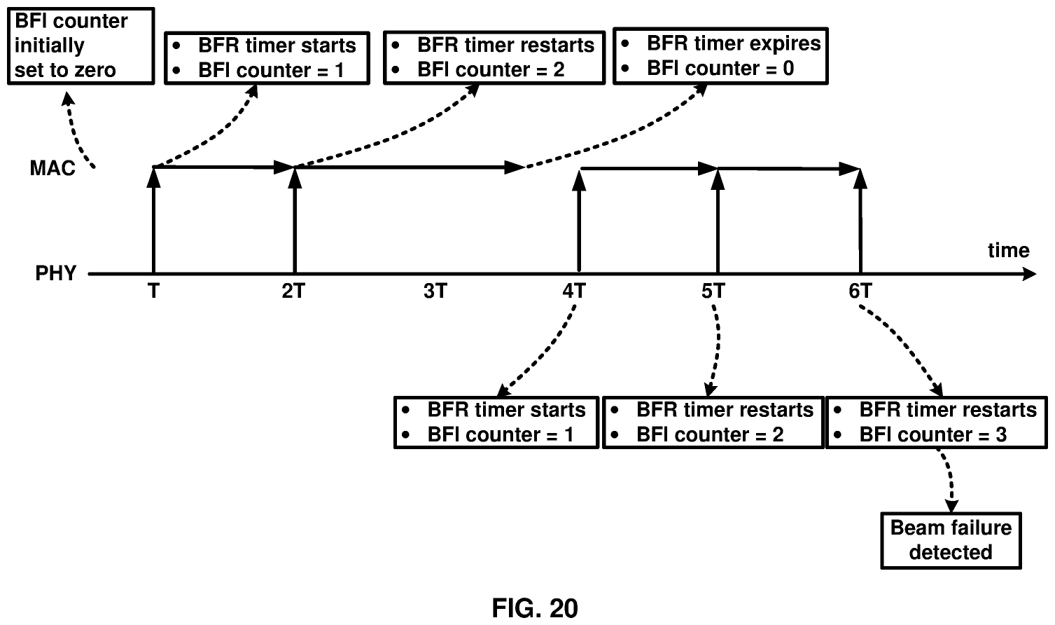

FIG. 20 shows an example of a beam failure instance (BFI) indication. In an example, a wireless device may use at least one UE variable for a beam failure detection. In an example, BFI_COUNTER may be one of the at least one UE variable. The BFI_COUNTER may be a counter for a beam failure instance indication. The wireless device may set the BFI_COUNTER initially to zero.

In an example, a MAC entity of a wireless device may receive a beam failure instance (BFI) indication from a lower layer (e.g., PHY) of the wireless device. Based on the receiving the BFI indication, the MAC entity of the wireless device may start or restart the beamFailureDetectionTimer (e.g., BFR timer in FIG. 20). Based on the receiving the BFI indication, the MAC entity of the wireless device may increment BFI_COUNTER by one (e.g., at time T, 2T, 5T in FIG. 20).

In an example, the BFI_COUNTER may be equal to or greater than the beamFailureInstanceMaxCount. Based on the BFI_COUNTER being equal to or greater than the beamFailureInstanceMaxCount, the MAC entity of the wireless device may initiate a random-access procedure (e.g., on an SpCell) for a beam failure recovery.

In an example, in FIG. 20, the wireless device may initiate the random-access procedure at time 6T, when the BFI_COUNTER is equal to or greater than the beamFailureInstanceMaxCount (e.g., 3).

In an example, the wireless device may select an uplink carrier (e.g., SUL, NUL) to perform the random-access procedure for the beam failure recovery. In an example, the base station may configure an active uplink BWP of the selected uplink carrier with IE beamFailureRecoveryConfig. When the wireless device initiates the random-access procedure for the beam failure recovery, based on the active uplink BWP of the selected uplink carrier being configured with the IE beamFailureRecoveryConfig, the wireless device may start, if configured, the beamFailureRecoveryTimer. When the wireless device initiates the random-access procedure for the beam failure recovery, based on the active uplink BWP of the selected uplink carrier being configured with the IE beamFailureRecoveryConfig, the wireless device may apply one or more parameters (e.g., powerRampingStep, preambleReceivedTargetPower, and preambleTransMax) configured in the IE BeamFailureRecoveryConfig for the random-access procedure.

In an example, the base station may configure powerRampingStepHighPriority in the IE beamFailureRecoveryConfig. When the wireless device initiates the random-access procedure for the beam failure recovery and the active uplink BWP of the selected uplink carrier is configured with the IE beamFailureRecoveryConfig, based on the powerRampingStepHighPriority being configured in the IE beamFailureRecoveryConfig, the wireless device may set PREAMBLE_POWER_RAMPING_STEP to the powerRampingStepHighPriority.

In an example, the base station may not configure powerRampingStepHighPriority in the IE beamFailureRecoveryConfig. When the wireless device initiates the random-access procedure for the beam failure recovery and the active uplink BWP of the selected uplink carrier is configured with the IE beamFailureRecoveryConfig, based on the powerRampingStepHighPriority not being configured in the IE beamFailureRecoveryConfig, the wireless device may set PREAMBLE_POWER_RAMPING_STEP to the powerRampingStep.

In an example, the base station may configure scalingFactorBI in the IE beamFailureRecoveryConfig. When the wireless device initiates the random-access procedure for the beam failure recovery and the active uplink BWP of the selected uplink carrier is configured with the IE beamFailureRecoveryConfig, based on the scalingFactorBI being configured in the IE beamFailureRecoveryConfig, the wireless device may set SCALING_FACTOR_BI to the scalingFactorBI.

In an example, the base station may configure the active uplink BWP of the selected uplink carrier with the IE beamFailureRecoveryConfig. Based on the active uplink BWP of the selected uplink carrier being configured with the IE beamFailureRecoveryConfig, the random-access procedure may be a contention-free random-access procedure.

In an example, the base station may not configure the active uplink BWP of the selected uplink carrier with the IE beamFailureRecoveryConfig. Based on the active uplink BWP of the selected uplink carrier not being configured with the IE beamFailureRecoveryConfig, the random-access procedure may be a contention-based random-access procedure.

In an example, the beamFailureDetectionTimer may expire. Based on the beamFailureDetectionTimer expiring, the MAC entity of the wireless device may set the BFI_COUNTER to zero (e.g., in FIG. 20, between time 3T and 4T).

In an example, a base station may configure a wireless device with one or more first RSs (e.g., SS/PBCH block, CSI-RS, etc.) for a beam failure detection (e.g., by RadioLinkMonitoringRS in the IE RadioLinkMonitoringConfig). In an example, the base station may reconfigure the beamFailureDetectionTimer or the beamFailureInstanceMaxCount or at least one RS of the one or more first RSs by higher layers (e.g., RRC). Based on the reconfiguring, the MAC entity of the wireless device may set the BFI_COUNTER to zero.

In an example, the wireless device may complete the random-access procedure (e.g., contention-free random-access or contention-based random-access) for the beam failure recovery successfully. Based on the completing the random-access procedure successfully, the wireless device may determine/consider that the beam failure recovery is successfully completed.

In an example, the wireless device may complete the random-access procedure for the beam failure recovery successfully. Based on the completing the random-access procedure successfully, the wireless device may, if configured, stop the beamFailureRecoveryTimer. Based on the completing the random-access procedure successfully, the wireless device may set the BFI_COUNTER to zero.

In an example, the beamFailureRecoveryTimer may be running. In an example, the base station may not configure the wireless device with the beamFailureRecoveryTimer. In an example, the base station may provide the wireless device with one or more second RSs (e.g., SS/PBCH blocks, periodic CSI-RSs, etc.) for a beam failure recovery by a higher layer parameter candidateBeamRSList in the IE beamFailureRecoveryConfig. In an example, the base station may provide the wireless device with one or more uplink resources (e.g., contention-free random-access resources) for a beam failure recovery request (BFRQ) used in the beam failure recovery by a higher layer (e.g., RRC) parameter (e.g., candidateBeamRSList, ssb-perRACH-Occasion, ra-ssb-OccasionMaskIndex in the IE beamFailureRecoveryConfig). An uplink resource of the one or more uplink resources may be associated with a candidate RS (e.g., SSB, CSI-RS) of the one or more second RSs. In an example, the association between the uplink resource and the candidate RS may be one-to-one.

In an example, at least one RS among the one or more second RSs may have a RSRP (e.g., SS-RSRP, CSI-RSRP) higher than a second threshold (e.g., rsrp-ThresholdSSB, rsrp-ThresholdCSI-RS). In an example, the wireless device may select a candidate RS among the at least one RS for the beam failure recovery.

In an example, the candidate RS may be a CSI-RS. In an example, there may be no ra-PreambleIndex associated with the candidate RS. Based on the candidate RS being the CSI-RS and no ra-PreambleIndex being associated with the candidate RS, the MAC entity of the wireless device may set PREAMBLE_INDEX to an ra-PreambleIndex. The ra-PreambleIndex may be associated/corresponding to an SSB in the one or more second RSs (e.g., indicated candidateBeamRSList). The SSB may be quasi-collocated with the candidate RS.

In an example, the candidate RS may be a CSI-RS and there may be ra-PreambleIndex associated with the candidate RS. In an example, the candidate RS may be an SSB. The MAC entity of the wireless device may set PREAMBLE_INDEX to a ra-PreambleIndex, associated/corresponding to the candidate RS, from a set of random-access preambles for the BFRQ. In an example, a higher layer (RRC) parameter may configure the set of random-access preambles for the BFRQ for the random-access procedure for the beam failure recovery.

In an example, a MAC entity of a wireless device may transmit an uplink signal (e.g., contention-free random-access preamble) for the BFRQ. Based on the transmitting the uplink signal, the MAC entity may start a response window (e.g., ra-ResponseWindow configured in the IE BeamFailureRecoveryConfig) at a first PDCCH occasion from the end of the transmitting the uplink signal. Based on the transmitting the uplink signal, the wireless device may, while the response window is running, monitor at least one PDCCH on a search space indicated by recoverySearchSpaceId (e.g., of an SpCell) for a DCI. The DCI may be identified by an RNTI (e.g., C-RNTI, MCS-C-RNTI) of the wireless device.

In an example, the MAC entity of the wireless device may receive, from a lower layer (e.g., PHY) of the wireless device, a notification of a reception of the DCI on the search space indicated by the recoverySearchSpaceId. In an example, the wireless device may receive the DCI on a serving cell. In an example, the wireless device may transmit the uplink signal via the serving cell. In an example, the DCI may be addressed to the RNTI (e.g., C-RNTI) of the wireless device. In an example, based on the receiving the notification and the DCI being addressed to the RNTI, the wireless device may determine/consider the random-access procedure being successfully completed.

In an example, the wireless device may transmit the uplink signal on an SpCell. In an example, the response window configured in the IE BeamFailureRecoveryConfig may expire. In an example, the wireless device may not receive a DCI (or a PDCCH transmission) addressed to the RNTI of the wireless device on the search space indicated by recoverySearchSpaceId on the serving cell (e.g., before the response window expires). Based on the response window expiring and not receiving the DCI, the wireless device may consider a reception of a random-access response (e.g., BFR response) unsuccessful. Based on the response window expiring and not receiving the DCI, the wireless device may increment a transmission counter (e.g., PREAMBLE_TRANSMISSION_COUNTER) by one. In an example, the transmission counter may be equal to preambleTransMax plus one. Based on the transmission counter being equal to the preambleTransMax plus one and transmitting the uplink signal on the SpCell, the wireless device may indicate a random-access problem to upper layers (e.g., RRC).

In an example, the MAC entity of the wireless device may stop the response window (and hence monitoring for the random access response) after successful reception of the random-access response (e.g., the DCI addressed to the RNTI of the wireless device, BFR response) in response to the random access response comprising a random access preamble identifier that matches the transmitted PREAMBLE_INDEX.

In an example, based on completion of a random-access procedure, a MAC entity of a wireless device may discard explicitly signaled contention-free random-access resources except one or more uplink resources (e.g., contention-free random-access resources) for BFRQ.

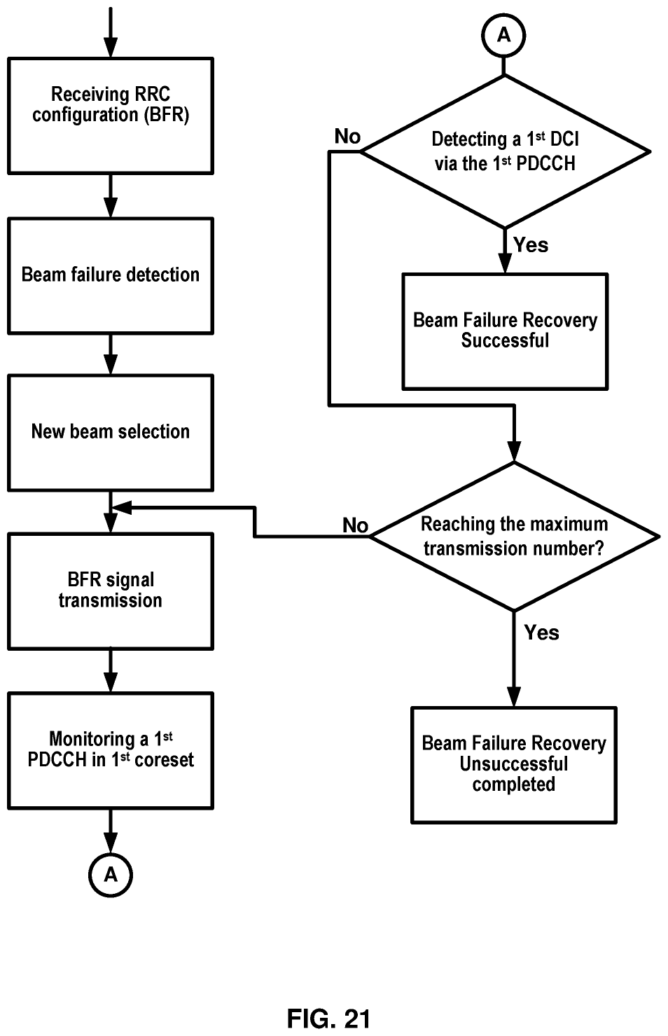

FIG. 21 shows an example flowchart of a BFR procedure. A wireless device may receive one or more RRC messages comprising BFR parameters. The one or more RRC messages may comprise an RRC message (e.g., RRC connection reconfiguration message, or RRC connection reestablishment message, or RRC connection setup message). The wireless device may detect at least one beam failure according to at least one of BFR parameters. The wireless device may start a first timer if configured in response to detecting the at least one beam failure. The wireless device may select a selected beam (e.g., a new candidate beam) in response to detecting the at least one beam failure. The selected beam may be a beam with good channel quality (e.g., RSRP, SINR, or BLER) from a set of candidate beams. The candidate beams may be identified by a set of reference signals (e.g., SSBs, or CSI-RSs). The wireless device may transmit at least a first BFR signal to a gNB in response to the selecting/identifying the selected beam. The at least first BFR response may be associated with the selected beam (e.g., a TCI state of a BFR-CORESET is determined based on the selected beam or the new candidate beam reported by the wireless device during BFR procedure). The at least first BFR signal may be a preamble transmitted on a PRACH resource, or a beam failure recovery request (e.g., similar to scheduling request) signal transmitted on a PUCCH resource, or a beam indication (e.g., BFR MAC CE) transmitted on a PUSCH resource. At least when the first BFR signal is a preamble signal, the wireless device may determine a spatial TX filter of the PRACH based on the selected beam (e.g., the new candidate beam) for the recovery. For example, when the downlink and uplink beams are corresponding (e.g., the UE support beam correspondence capability), a PRACH occasion corresponding to the new candidate beam based on RACH occasion/configurations is selected. The wireless device may start a response window in response to transmitting the at least first BFR signal.

In some examples, the response window may be a timer with a value configured by the gNB. When the response window is running, the wireless device may monitor a PDCCH in a first coreset (e.g., UE specific or dedicated to the wireless device or wireless device specific). The first coreset may be associated with the BFR procedure. In an example, the wireless device may monitor the PDCCH in the first coreset in response to transmitting the at least first BFR signal. The wireless device may receive a first DCI via the PDCCH in the first coreset when the response window is running. The wireless device may consider the BFR procedure successfully completed when receiving the first DCI via the PDCCH in the first coreset before the response window expires. The wireless device may stop the first timer if configured in response to the BFR procedure successfully being completed. The wireless device may stop the response window in response to the BFR procedure successfully being completed.

In an example, when the response window expires where the wireless device may not have received a response (e.g., a scheduling DCI for the response), the wireless device may increment a transmission number. The transmission number will be set to zero (or initialized) at the BF is detected and/or after the BFR procedure is completed. Until the transmission number may reach a threshold, the wireless device may attempt multiple times of beam failure recovery procedure (e.g., RACH procedure). If the transmission number indicates a number less than the configured maximum transmission number, the wireless device may repeat one or more actions comprising at least one of: a BFR signal transmission; starting the response window; monitoring the PDCCH; incrementing the transmission number if no response is received when the response window is running. If the transmission number indicates a number equal or greater than the configured maximum transmission number, the wireless device may declare the BFR procedure is unsuccessfully completed.

The base station may transmit one or more radio resource control (RRC) messages comprising/indicating configuration parameters for cross-carrier scheduling of a first cell. For example, the configuration parameters may comprise a scheduling cell index (e.g., a second cell) for the first cell, and a carrier indicator (CI). The wireless device may apply the cross-carrier scheduling for the first cell for one or more DCI formats (e.g., non-fallback DCI formats, DCI format 1_1/DCI format 0_1, DCI format 1_2/DCI format 0_2). The wireless device may apply one or more search spaces configured for the first cell to monitor fallback DCI formats based on the self-carrier scheduling. For example, the configuration parameters may comprise the one or more DCI formats to be monitored via the cross-carrier scheduling for the first cell. For example, the configuration parameter may comprise one or more search spaces and/or one or more search space indices and/or one or more CORESETs and/or one or more CORESET indices where the wireless device may monitor DCIs for the first cell, via the second cell based on the cross-carrier scheduling. The wireless device may determine a corresponding search space of the second cell and/or a corresponding CORESET of the second cell for a search space and/or a CORESET of the one or more search spaces and/or the one or more CORESETs based on the configuration parameters based on the cross-carrier scheduling.

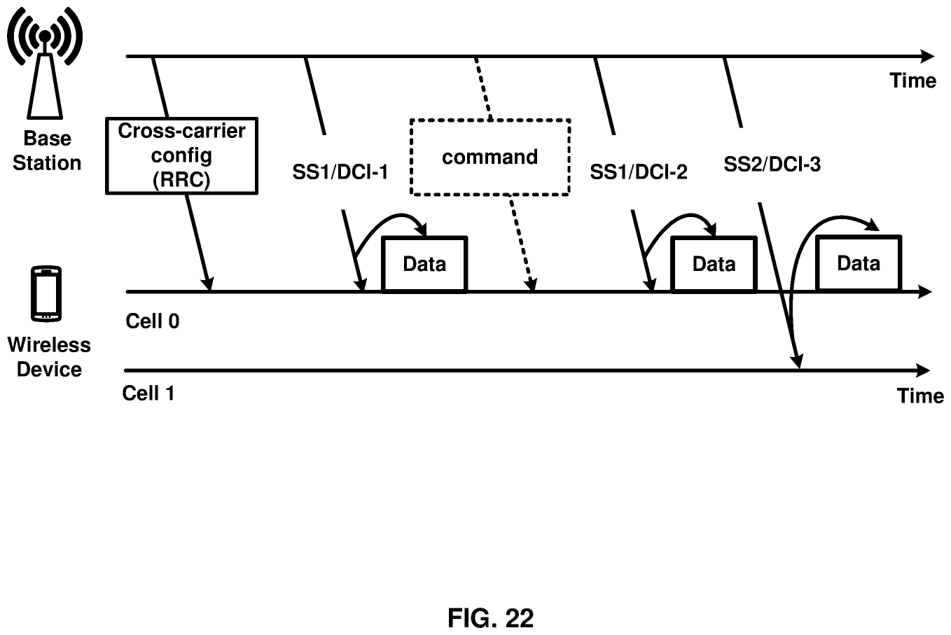

FIG. 22 illustrates an example of a cell (Cell 1) configured with both self-carrier and cross-carrier scheduling. The base station configures cross-carrier scheduling for a first cell (Cell 0), wherein a scheduling cell is a second cell (Cell 1). The wireless device may receive a first DCI (DCI-1) comprising a resource assignment for the first cell. The wireless device receives the first DCI and corresponding data via the first cell. The wireless device may receive a command activating/starting/triggering/indicating the cross-carrier scheduling. The command may comprise or indicate or update a scheduling cell. The command may be implicitly given. For example, a MAC CE activating the second cell may be used as the command to activate the cross-carrier scheduling for the first cell. For example, a power saving indication to switch the second from a dormant state to a non-dormant state may be used as the command to activate the cross-carrier scheduling for the first cell. The base station may transmit a second DCI (DCI-2) via a search space of the first cell (SS1). The base station may transmit a third DCI (DCI-3) via a second search space of the second cell (SS2). The first DCI and the second DCI may schedule data for the first cell. The wireless device receives corresponding data based on the second DCI and the third DCI. For example, the wireless device may receive the third DCI based on a non-fallback DCI format (e.g., DCI format 1_1, DCI format 1_2). For example, the wireless device may receive the second DCI based on a fallback DCI format (e.g., DCI format 1_0). For example, the second DCI may be CRC scrambled with a first RNTI. The first RNTI may be one of C-RNTI, CS-RNTI, and/or MCS-C-RNTI. The third DCI may be CRC scrambled with a second RNTI. The second RNTI may be different from the first RNTI. The second RNTI may be same to the first RNTI.

In an example, a base station may schedule a first resource of a first cell and a second resource of a second cell via a DCI. For example, the DCI may schedule a plurality of cells. The DCI may be called as a multi-cell DCI. The multi-cell DCI may comprise a plurality of resource assignments across a plurality of cells. For example, the plurality of cells may comprise a first cell and a second cell. The base station may transmit the multi-cell DCI via the first cell. The base station may transmit the multi-cell DCI via the second cell. The base station may transmit the multi-cell DCI via a third cell. The multi-cell DCI may schedule a transport block, wherein resources for carrying the transport block may be across the plurality of cells. The multi-cell DCI may schedule one or more transport blocks for each cell of the plurality of cells. The multi-cell may comprise/indicate a plurality of HARQ processes mapped to each cell of the plurality of the cells and/or mapped to each transport block.

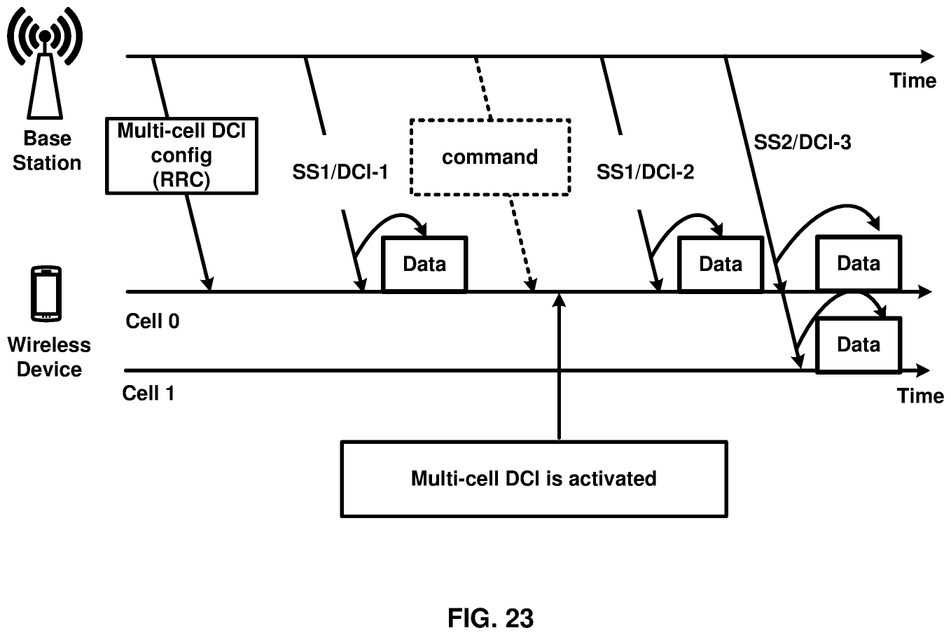

FIG. 23 illustrates an example of a multi-cell DCI configuration. The base station configures configuration parameters for a multi-cell operation for a first cell and a second cell, wherein the second cell is configured as a scheduling cell. For example, the configuration parameters may comprise a scheduling cell index. For example, the configuration parameters may comprise one or more DCI formats used for the multi-cell DCI. For example, the configuration parameters may comprise a plurality of cells that the multi-cell DCI schedules for. For example, the configuration parameters may comprise one or more parameters for scheduling, and/or parameters for DCI fields of the one or more DCI formats for the multi-cell DCI and/or parameters for PDSCH and/or parameters for PUSCH and/or one or more HARQ processes used for the multi-cell DCI and/or one or more PUCCH resources. For example, the configuration parameters may comprise a resource block group size, a resource allocation type (e.g., between type 0 and type 1). For example, the configuration parameters may comprise a first frequency region of the first cell, wherein the multi-cell may schedule a resource across the first frequency region. For example, the configuration parameters may comprise a second frequency region of the second cell, wherein the multi-cell may schedule a second resource across the second frequency region.

The base station transmits a first DCI (DCI-1) via a first search space of the first cell (Cell 0), wherein the first DCI comprises a resource assignment of the first cell only (e.g., a single-cell DCI). The wireless device receives the data based on the first DCI on the first cell. The base station may activate the multi-cell scheduling based on a command. The command may be a MAC CE activation activating the second cell. In response to activation of the second cell, the wireless device may activate the multi-cell scheduling where the scheduling cell is the second cell. The command may be a power saving indication to switch the second from a dormant state to a non-dormant state may be used as the command to activate the multi-cell scheduling for the first cell. The base station transmits a second DCI (DCI-2) via a single-cell DCI for the first cell via the first search space of the first cell. The base station transmits a third DCI (DCI-3), a multi-cell DCI, via a second search space (SS2) of the second cell. The third DCI comprises a first resource assignment for the first cell and a second resource assignment for the second cell. The wireless device receives the first data on the first cell based on the first resource assignment. The wireless device receives the second data on the second cell based on the second resource assignment.

In existing technologies, a wireless device may perform a radio link monitoring for a primary cell of a cell group (e.g., a master cell group and/or a secondary cell group). The wireless device may monitor/measure radio link qualities of one or more reference signals transmitted via the primary cell. The wireless device may be configured for self-carrier scheduling of the primary cell. If there is a radio link failure of the primary cell, the wireless device may not be able to receive a downlink control information (DCI). The DCI may include important information, such as a scheduling of SIB and/or an RAR transmission. As a result, the base station may not be able to communicate with the wireless device due to the radio link failure.

Existing mechanisms may be inefficient in scenarios where a base station configures a cross-carrier scheduling for a primary cell. For example, a secondary cell may schedule resources for the primary cell. When a primary cell is configured with cross-carrier scheduling, the wireless device may be configured to receive downlink control information via the secondary cell that is different from the primary cell. As a result, radio link quality of the primary cell may be an incomplete basis for identifying radio link failure. For example, existing mechanisms may determine, based on a radio link quality of the primary cell, to transition to an RRC IDLE state and/or search for a handover candidate cell. When a link quality of the secondary cell is good, the wireless device may be able to maintain a connectivity to the base station via the secondary cell. Implementation of existing technologies may lead a radio link failure of the cell group, even though the base station is able to communicate with the wireless device. This process may increase power consumption and may increase signaling overhead for example due to a handover procedure, reconfiguration and/or recovery signaling.

In an example, the wireless device may determine one or more reference signals for a radio link monitoring (RLM) of the cell group based on one or more CORESETs of the primary cell. When the wireless device is configured with the cross-carrier scheduling for the primary cell, the wireless device may not be configured with any CORESET or may be configured with a limited number of CORESETs (e.g., 1) for an active BWP of the primary cell. One or more reference signals based on the limited number of CORESETs may be insufficient to perform RLM for the cell group. For example, when the wireless device is configured with a single CORESET for the active BWP of the primary cell, the wireless device may determine a radio link failure based on a single reference signal associated with the single CORESET.

A low number of available reference signals (including zero reference signals) may reduce a performance of the RLM measurement. This may lead to more frequent RLF or may lead to inefficient/inaccurate radio link quality measurements. Enhancements in a RLM procedure, when a primary cell is cross-carrier scheduled, are needed.

In an example, a wireless device may receive one or more RRC messages indicating configuration parameters of physical downlink control channels (PDCCHs) for scheduling a primary cell. The configuration parameters may indicate one or more first coresets of the primary cell. The configuration parameters may indicate one or more second coresets of a secondary cell. For example, the second cell may be configured as a scheduling cell for the primary cell based on a cross-carrier scheduling configuration. In response to the secondary cell cross-carrier scheduling the primary cell, the wireless device may determine radio link monitoring reference signals (RLM-RSs) based on the one or more first coresets of the primary cell and the one or more second coresets of the secondary cell.

In an example, the RLM-RSs may comprise a first reference signal and a second reference signal. For example, one or more reference signals, of TCI state(s) of the one or more first coresets, may comprise the first reference signal. For example, one or more second reference signals, of TCI state(s) of the one or more second coresets, may comprise the second reference signal. In some examples, the wireless device may measure the RLM-RSs for radio link monitoring.

Example embodiments may allow a wireless device to utilize one or more reference signals of a scheduling cell, in addition to one or more first reference signals of a primary cell. For example, the wireless device may utilize the one or more reference signals of the scheduling cell, for a radio link monitoring, when the primary cell is configured with a cross-carrier scheduling. Embodiments may allow more accurate and less frequent radio link failure events based on measurement on downlink radio link qualities measured on actual scheduling cell and downlink radio link qualities measured on the primary cell.

In an example, the wireless device may determine one or more first RLM-RSs based on the one or more first coresets of the primary cell. The wireless device may determine one or more second RLM-RSs based on the one or more second coresets of the secondary cell. The wireless device may measure the one or more first RLM-RSs for radio link monitoring. The wireless device may additionally measure the one or more second RLM-RSs in response to a number of the one or more first RLM-RSs being smaller than an allowed number of RLM-RSs.

For example, the allowed number of RLM-RSs may be pre-determined (e.g., 2 for a first frequency range). When the number of the one or more first RLM-RSs being equal to or greater than the allowed number of RLM-RSs, the wireless device may measure only the one or more first RLM-RSs for the radio link monitoring.

Example embodiment may enable to prioritize utilizing one or more reference signals of the primary cell. When RLM-RSs of the primary cell is limited/not sufficient, the wireless device may additionally utilize reference signal(s) of the secondary cell (e.g., scheduling cell). This may enhance a performance of radio link monitoring. This may reduce a complexity of the wireless device.

In an example, a wireless device may receive one or more RRC messages indicating configuration parameters for a radio link monitoring of a primary cell. The configuration parameters may comprise a first RLM-RS of the primary cell. The configuration parameters may comprise a second RLM-RS of a secondary cell. The secondary cell may be a scheduling cell for the primary cell. The configuration parameters may indicate a cell index indicating the secondary cell at least for the secondary RLM-RS. The wireless device may measure the first RLM-RS and the second RLM-RS. The wireless device may detect a radio link failure based on the measurements of the first RLM-RS and the second RLM-RS.

The wireless device may initiate a radio link failure recovery procedure (e.g., RRC reestablishment, RRC setup, RRC reconfiguration, etc.) in response to detecting the radio link failure.

Example embodiments may allow a configuration of one or more RLM-RSs of one or more serving cells. For example, the one or more serving cells may comprise a primary cell. The one or more serving cells may additionally comprise a secondary cell that is a scheduling cell for the primary cell based on a cross-carrier scheduling.

Example embodiments may allow a wireless device to utilize one or more reference signals of a scheduling cell, in addition to one or more first reference signals of a primary cell. For example, the wireless device may utilize the one or more reference signals of the scheduling cell, for a radio link monitoring, when the primary cell is configured with a cross-carrier scheduling. Embodiments may allow more accurate and less frequent radio link failure events based on measurement on downlink radio link qualities measured on actual scheduling cell and downlink radio link qualities measured on the primary cell.

Example embodiments may enhance a flexibility by a base station to configure one or more RLM-RSs via one or more serving cells based on a cross-carrier scheduling. For example, the base station may configure one or more RLM-RSs of the primary cell only. The base station may configure one or more RLM-RSs of the secondary cell only. The base station may configure one or more RLM-RSs of the primary cell and the secondary cell.

In existing technologies, a wireless device may determine one or more reference signals based on one or more coresets for a primary cell. The wireless device may monitor downlink control channels (e.g., PDCCHs) for the primary cell via the one or more coresets. A base station may configure a cross-carrier scheduling for the primary cell. A secondary cell may cross-carrier schedule the primary cell. For example, the base station may configure one or more second coresets of the secondary cell for the primary cell.

The base station may configure one or more first coresets of the primary cell for scheduling the primary cell based on a self-carrier scheduling. The one or more coresets may comprise the one or more first coresets and the one or more second coresets.

The wireless device may perform a link quality monitoring for the primary cell based on the one or more coresets. The wireless device may determine a first reference signal of a first coreset of the primary cell. The wireless device may additionally determine a second reference signal of a second coreset of the secondary cell. The one or more coresets may comprise the first coreset and the second coreset.

Based on implementation of existing technologies, the wireless device may determine a link failure, of the primary cell, based on signal qualities of the second reference signal of the second coreset of the secondary cell. Implementation of existing technologies may lead inaccurate link quality monitoring for the primary cell, when the primary cell is configured with a cross-carrier scheduling. Existing technologies may degrade performance.

In an example, a wireless device may receive configuration parameters of PDCCHs scheduling a primary cell. The configuration parameters may indicate a first coreset of the primary cell and a second coreset of a secondary cell. The first coreset may be associated with a first reference signal and may be used for a self-carrier scheduling of the primary cell. The second coreset may be associated with a second reference signal and may be used for a cross-carrier scheduling for the primary cell.

The wireless device may select, as a link quality monitoring reference signal, the first reference signal from the first reference signal and the second reference signal. The wireless device may select the first reference signal based on the primary cell comprising the first coreset. The wireless device may not monitor the second reference signal for the link quality monitoring for the primary cell. The wireless device may initiate a link recovery procedure based on measurement of the link quality monitoring reference signal.

Example embodiments may enhance a link quality monitoring of the primary cell when the primary cell is configured with a cross-carrier scheduling. Example embodiments may enhance a link quality recovery procedure of the primary cell based on one or more coresets for monitoring PDCCHs scheduling the primary cell.

In existing technologies, a wireless device may be configured with a cell group comprising a first cell and a second cell. A base station may indicate a transition of the cell group between a dormant state and a normal state. The wireless device may transition the first cell and the second cell to the dormant state in response to receiving a DCI indicating the transition of the cell group to the dormant state. For example, the first cell may be configured as a scheduling cell for a primary cell. Based on the implementation of existing technologies, the wireless device may transition the first cell to the dormant state in response to the DCI.

This may lead performance degradation as the wireless device may not receive scheduling DCIs for the primary cell based on the dormant state of the first cell.

In an example, a wireless device may receive configuration parameters. The configuration parameters may indicate a cell group. The cell group may comprise one or more secondary cells for applying DDCI indicating a transition of the one or more secondary cells of the cell group to a dormant state. The configuration parameters may indicate a first secondary cell of the one or more secondary cells. The first secondary cell may be configured as a scheduling cell for the primary cell based on a cross-carrier scheduling.

The wireless device may receive a first DCI indicating a transition of the cell group to the dormant state. In response to receiving the first DCI and based on the first secondary cell cross-carrier scheduling the primary cell, the wireless device may transition the one or more secondary cells, other than the first secondary cell, to the dormant state.

Example embodiments may ensure a scheduling cell of the primary cell in a normal state while maintaining a flexibility of a cell group configuration. Example embodiments may allow a flexibility in changing a scheduling secondary cell of the primary cell without reconfiguration of a cell group for a dormancy mechanism.

In an example, a wireless device may perform a radio link monitoring for a first cell of a cell group based on a plurality of reference signals to identify a radio link quality of the first cell. For example, the wireless device may receive one or more radio resource control (RRC) messages indicating the plurality of reference signals comprising a first reference signal and a second reference signal. For example, the first reference signal is a reference signal of the first cell. For example, the second reference signal is a reference signal of a scheduling cell for the first cell. The wireless device may receive one or more second RRC messages indicating a second cell as the scheduling cell for the first cell, wherein the first cell may be configured with cross-carrier scheduling and/or with multi-carrier/cell scheduling. In response to being configured with cross-carrier scheduling or the multi-carrier scheduling for the first cell, the wireless device may monitor first DCIs via one or more first search spaces of the first cell, wherein the first DCIs may comprise resource assignments for the first cell. In response to being configured with cross-carrier scheduling or the multi-carrier scheduling for the first cell, the wireless device may monitor second DCIs via one or more second search spaces of the second cell, wherein the second DCIs may comprise resource assignments for the first cell.

The wireless device may measure a first radio link quality based on the first reference signal of the first cell. The wireless device may determine a second radio link quality based on the second reference signal of the second cell. The wireless device may determine an out-of-sync event when the first link quality and the second link quality become lower than a second threshold (e.g., Qout). When the plurality of reference signals may comprise additional reference signals, the wireless device may determine the out-of-sync event when radio link qualities of the plurality of reference signals become lower than the second threshold (e.g., Qout). For example, the wireless device may determine the out-of-sync event based on all radio link qualities of the plurality of reference signals become lower than the second threshold. For example, the wireless device may determine the out-of-sync event based on radio link qualities of reference signals of the first cell from the plurality of reference signals become lower than the second threshold. For example, the wireless device may determine the out-of-sync event based on an average radio link quality of the radio link qualities of the plurality of reference signals becomes lower than the second threshold. For example, the wireless device may determine the out-of-sync event based on radio link quality(s) of at least one reference signal from the plurality of reference signals becomes lower than the second threshold. For example, the wireless device may determine the out-of-sync event based on radio link qualities of reference signals of the second cell from the plurality of reference signals become lower than the second threshold.

The wireless device may determine an in-sync event when the first link quality or the second link quality becomes better than a first threshold (e.g., Qin). When the plurality of reference signals may comprise additional reference signals, the wireless device may determine the in-sync event when radio link quality of at least one reference signal from the plurality of reference signals become better than the first threshold (e.g., Qin). For example, the wireless device may determine the in-sync event based on all radio link qualities of the plurality of reference signals become better than the first threshold. For example, the wireless device may determine the in-sync event based on radio link quality(s) of at least one reference signal of the first cell from the plurality of reference signals becomes better than the first threshold. For example, the wireless device may determine the in-sync event based on radio link qualities of all reference signals of the first cell from the plurality of reference signals become lower than the first threshold. For example, the wireless device may determine the in-sync event based on an average radio link quality of the radio link qualities of the plurality of reference signals becomes better than the first threshold. For example, the wireless device may determine the in-sync event based on radio link quality(s) of at least one reference signal of the scheduling cell from the plurality of reference signals becomes better than the first threshold. For example, the wireless device may determine the in-sync event based on radio link qualities of all reference signals of the second cell from the plurality of reference signals become lower than the first threshold.

In an example, the first cell may be a primary cell of a cell group (e.g., PCell, PSCell) or a cell supporting a radio link monitoring (e.g., a PUCCH cell). In an example, the second cell may be a secondary cell of the cell group.

Based on the out-of-sync events/measurements, the wireless device may determine/declare a radio link failure (RLF) for the first cell. The wireless device may initiate a recovery procedure in response to the RLF. For example, the wireless device may search a candidate cell to hand-over. For example, the wireless device may transition to a RRC IDLE state in response to failure of identifying/searching the candidate cell within a time duration.

In an example, a base station may transmit one or more RRC messages comprising a parameter of RadioLinkMonitoringConfig. The RadioLinkMonitoringConfig may comprise one or more failureDetectionResources (RLM-RSs), beamFailureInstanceMaxCount and beamFailureDetectionTimer. The RadioLinkMonitoringConfig may be used for performing a radio link monitoring and a link quality monitoring for identifying/detecting a beam failure. A failureDetectionResource (RLM-RS) may be configured as a RadioLinkMonitoringRS from one or more configured RadioLinkMonitoringRSs. Each RadioLinkMonitoringRS may comprise a radioLinkMonitornigRS-Id (e.g., an index of RadioLinkMonitoringRS), a purpose and a detectionResource. For example, the purpose may be one of beamFailure (e.g., used for link quality monitoring only), rlf (e.g., used for radio link monitoring only), or both (e.g., used for both link quality monitoring and radio link monitoring). For example, the detectionResource may comprise a ssb-Index or a csi-rs-Index depending on a reference signal associated with the RadioLinkMonitoringRS. The wireless device may be configured with a CSI-RS with the purpose of either beamFailure or both. In an example, the RadioLinkMonitoringRS may comprise a cell index (e.g., a first index for the first cell (e.g., the first index=0), a second index for the second cell (e.g., the second index=1)). The cell index may represent a cell index of the detectionResource (e.g., SSB or CSI-RS). For example, a third RadioLinkMonitoringRS for the third RLM-RS may comprise a cell index of the second cell, as the third RLM-RS is the RS of the second cell. In response to an absence of a cell index in a RadioLinkMonitoringRS, the wireless device may assume that the cell index is same as the first cell, where the RadioLinkMonitoringRS is configured for the first cell (e.g., a serving cell where the configuration is given).

In an example, the base station may not configure a RadioLinkMonitoringRS with a cell index, wherein the cell index is different from an index of the first cell (e.g., a different cell from the first cell), for the first cell for a link quality monitoring (e.g., a purpose of the RadioLinkMonitoringRS is either beamFailure or both). For example, the wireless device may use a RadioLinkMonitoringRS, wherein the cell index is same as the first cell or the cell index is absent, for performing the link quality monitoring to identify/detect a beam failure of the first cell. In the example, embodiments may apply when the first cell is a primary cell. A base station may configure a RadioLinkMonitoringRS or a link quality monitoring reference signal, where detectionResource is a reference signal of a third cell for a fourth cell, wherein the fourth cell may be a secondary cell. The third cell may be a primary cell or a secondary cell. When the first cell is a primary cell, the wireless device may expect one or more reference signals, used for the link quality monitoring (e.g., beam failure detection), are transmitted via the first cell. When the first cell is a secondary cell, the wireless device may expect the one or more reference signals, used for the link quality monitoring (e.g., beam failure detection), are transmitted via the first cell or are transmitted via a second cell.

In an example, a detectionResource of a RadioLinkMonitoringRS, where the detectionResource indicates a reference signal of a second cell, wherein the RadioLinkMonitoringRS is configured for a first cell, the detectionResource may be a periodic CSI-RS. In an example, a base station may configure RadioLinkMonitoringConfig, wherein the RadioLinkMonitoringConfig may comprise one or more RadioLinkMonitoringRSs and one or more SCellRadioLinkMonitoringRSs. The RadioLinkMonitoringConfig may comprise a scellIndex indicating a cell index for the one or more SCellRadioLinkMonitoringRSs. The RadioLinkMonitoringRS may comprise one or more detectionResources of the first cell. The SCellRadioLinkMonitoringRS may comprise one or more detectionResources of the second cell, a scheduling cell for the first cell based on cross-carrier scheduling. The SCellRadioLinkMonitoringRS may comprise an index for SCellRadioLinkMonitoringRS (e.g., scellradioLinkMonitoringRS-Id) and a csi-RS-Index. The SCellRadioLinkMonitoringRS may be used for performing a radio link quality monitoring (e.g., RLM). The SCellRadioLinkMonitoringRS may only comprise a CSI-RS. The SCellRadioLinkMonitoringRS may comprise the CSI-RS of the second cell indicated by the scellIndex. A base station may configure additional detectionResources of the second cell for the RLM of the first cell.

The wireless device may use the one or more RadioLinkMonitoringRS for performing a link quality monitoring (e.g., a beam failure detection, beam measurement, link quality measurement, etc.).

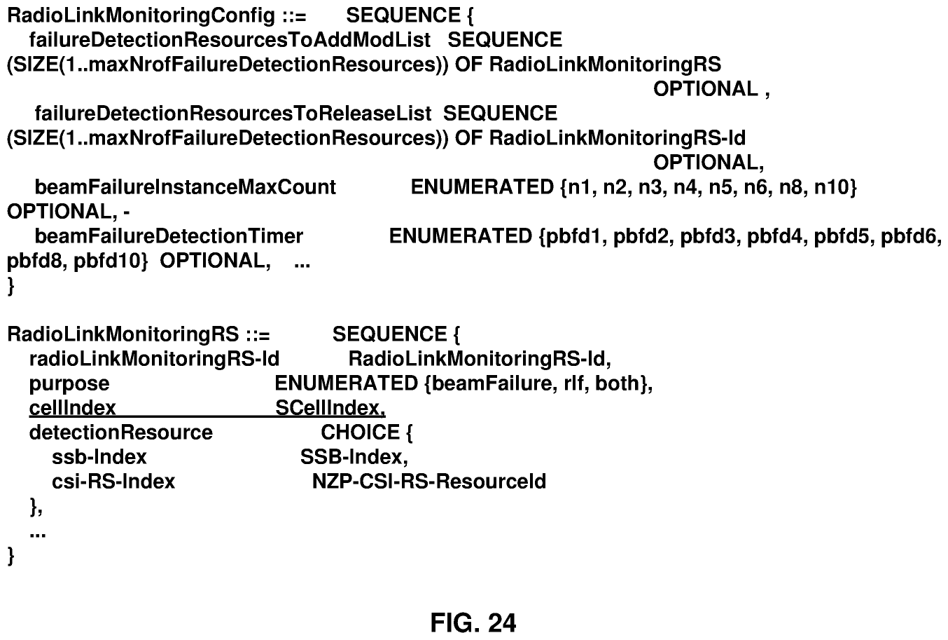

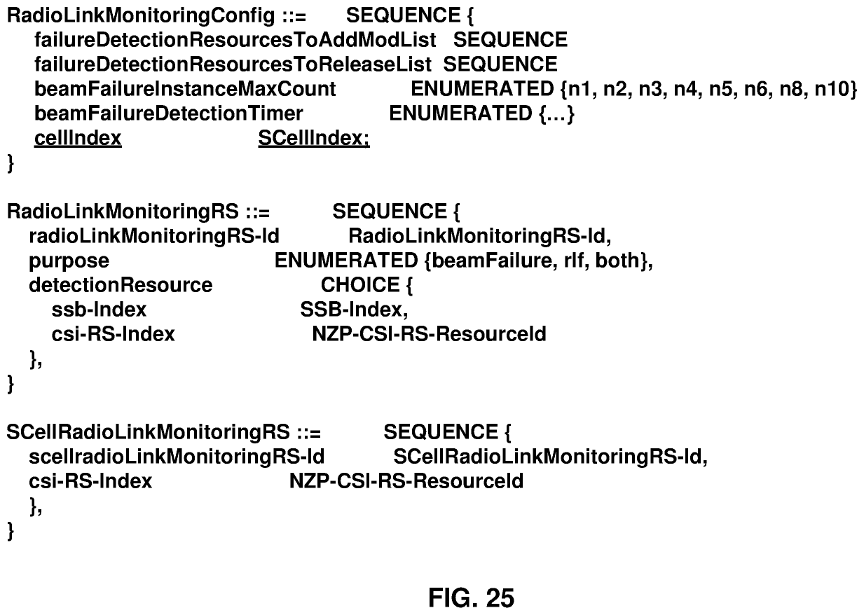

FIG. 24 and FIG. 25 illustrate example configuration parameters of RLM-RSs of embodiments. FIG. 24 illustrates a RadioLinkMonitoringConfig, comprising one or more RadioLinkMonitoringRSs (e.g., failureDetectionResources). A RadioLinkMonitoringRS (e.g., a failureDetectionResource) may comprise a cellIndex, an index of a cell transmitting a detectionResource of the RadioLinkMonitoringRS. The RadioLinkMonitoringRS may comprise an index of the RadioLinkMonitoringRS and a reference signal (e.g., detectionResource). The reference signal may be one of a SSB (e.g., indicated by a ssb-index) and a CSI-RS (e.g., indicated by a csi-RS-index).

FIG. 25 illustrates an example where a new parameter of SCellRadioLinkMonitoringRS for one or more RLM-RSs of the second cell for the first cell. The SCellRadioLinkMonitoringRS may comprise an index of the SCellRadioLinkMonitoringRS and a csi-RS-Index for a CSI-RS of the second cell. RadioLinkMonitoringConfig may comprise an index of the second cell (e.g., cellIndex). The SCellRadioLinkMonitoringRS may be used to configure one or more reference signals for a radio link monitoring of a primary cell. The cell index of the RadioLinkMonitoringConfig may indicate a secondary cell that cross-carrier schedules the primary cell. For example, the secondary cell may be configured as a scheduling cell for the primary cell based on a cross-carrier scheduling.

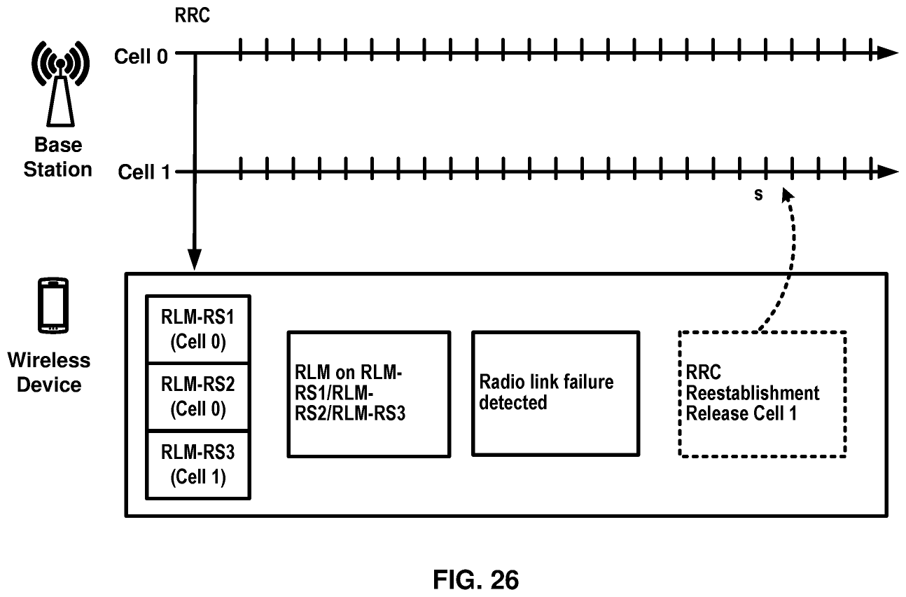

FIG. 26 illustrates an example of embodiments. For example, the base station configures a first cell (Cell 0) and a second cell (Cell 1) to the wireless device. The base station may configure a cross-carrier scheduling for the first cell, wherein the second cell is a scheduling cell for the first cell. In the example, the first cell may be a primary cell. The second cell may be a secondary cell. The wireless device may maintain self-carrier scheduling for the first cell in addition to cross-carrier scheduling. For example, the wireless device may monitor first DCIs based on one or more fallback DCI formats (e.g., DCI format 0_0/DCI format 1_0) via one or more first search spaces of the first cell. The wireless device may monitor second DCIs, for scheduling resources for the first cell, based on one or more non-fallback DCI formats (e.g., DCI format 0_1/DCI format 1_1) via one or more second search spaces of the second cell. In the example, the wireless device may support up to K=4 RLM-RSs for the first cell. The base station configures a first RLM-RS (RLM-RS1), wherein the first RLM-RS is a RS of the first cell. The base station configures a second RLM-RS (RLM-RS2), wherein the second RLM-RS is a second RS of the first cell. The base station configures a third RLM-RS (RLM-RS3), wherein the third RLM-RS is a RS of the second cell (e.g., the third RLM-RS is configured with a cell index of the second cell). The wireless device may measure link/signal qualities based on the RLM-RS1, RLM-RS2 and RLM-RS3. Based on the measurements, the wireless device may declare/detect a radio link failure, for example based on a procedure shown in FIG. 18.

In response to the declaring/detecting the radio link failure, the wireless device may identify a candidate cell a RRC re-establishment wherein the first cell is a primary cell of a master cell group (e.g., PCell). The wireless device may transmit a RRCReestablishmentRequest to a network (e.g., a second base station, the base station, etc.). Based on the request, the network may send RRCReestablishment command. The wireless device may perform the RRCReestablishment based on the command. The wireless device may transmit a RRCReestablishmentComplete when the RRC reestablishment is successfully completed. The network may send RRCSetup command in response to the RRCReestablishmentRequest instead of RRCReestablishment command. In response to the RRCSetup command, the wireless device may transmit a RRCSetupComplete when the RRC setup is successfully completed. When the first cell is a primary cell of a secondary cell group (e.g., SPCell), the wireless device may perform a recovery procedure of a SCG RLF. For example, the base station and the wireless device may perform an RRC reconfiguration. The wireless device may inform a SCGFailureInformation to the base station (e.g., to the base station of a master cell group). For example, the wireless device may transmit an RRC reestablishment request to the base station or to a network via a second base station. For example, the wireless device may release the second cell or one or more secondary cells of the cell group. The wireless device may re-establish an RRC connection via for example an intra-gNB/intra-cell handover or an inter-gNB/inter-cell handover. When the first cell is the primary cell of the SCG (secondary cell group), the wireless device may suspend transmissions of any cell of SCG and may reset a MAC of the SCG.

In an example, a wireless device may determine one or more RLM-RSs (failureDetectionResources) based on one or more first CORESETs of a first cell and one or more second CORESETs of a second cell. A base station may not configure a RadioLinkMonitoringRS for the first cell, wherein the wireless device may perform an RLM for the first cell. The wireless device may determine the one or more second CORESETs from one or more CORESETs configured for the second cell, based on a case that each of the one or more second CORESETs may transmit a DCI comprising a resource assignment for the first cell. The wireless device may determine the one or more second CORESETs based on one or more first search spaces of the first cell and one or more second search spaces of the second cell. The wireless device is configured with cross-carrier scheduling of the first cell via the second cell. The second cell may be configured as a scheduling cell for the first cell based on the cross-carrier scheduling.

For example, the wireless device may determine one or more third search spaces from the one or more second search spaces, wherein a first search space of the one or more first search spaces may have a same search space index to a second search space of the one or more third search spaces. The one or more third search spaces of the second cell may be for the cross-carrier scheduling the first cell. For example, the wireless device may determine the one or more third search spaces from the one or more second search spaces, wherein a first search space of the one or more first search spaces may have a same search space index to a second search space of the one or more third search spaces and one or more second DCI formats configured for the second search space comprise one or more first DCI formats configured for the first search space. For example, the wireless device may determine the one or more third search spaces from the one or more second search spaces, wherein a second search space of the one or more third search spaces may be configured with cross-carrier scheduling of the first cell. For example, the wireless device may determine the one or more third search spaces from the one or more second search spaces, wherein a second search space of the one or more third search spaces is configured with one or more non-fallback DCI formats (e.g., DCI format 1_1, DCI format 0_1, DCI format 1_2, DCI format 0_2).

In an example, when a total number of both the one or more first CORESETs and the one or more second CORESETs is smaller than or equal to a supported/allowed number of RLM-RSs, the wireless device may determine one or more reference signals associated with active TCI states of both the one or more first CORESETs and the one or more second CORESETs. The wireless device may consider/determine/assume a single reference signal, wherein a first reference signal of a first active TCI state is same as a second reference signal of a second active TCI state. The wireless device may consider/handle/process duplicate reference signals and determine unique one or more second reference signals from the one or more reference signals. The wireless device may determine the one or more second reference signals as the RLM-RSs for the first cell. The wireless device may determine a reference signal associated with an active TCI state based on a reference signal configured for the active TCI state for either qcl-Type1 or qcl-Type2 (comprising a typeD).

In an example, when a total number of both the one or more first CORESETs and the one or more second CORESETs is larger than a supported/allowed number of RLM-RSs, the wireless device may determine one or more reference signals associated with active TCI states of both the one or more first CORESETs and the one or more second CORESETs. The wireless device may consider/determine/assume a single reference signal, wherein a first reference signal of a first active TCI state is same as a second reference signal of a second active TCI state. The wireless device may consider/handle/process duplicate reference signals and determine unique one or more second reference signals from the one or more reference signals. When a total number of the one or more second reference signals are smaller than or equal to the supported/allowed number of RLM-RSs, the wireless device may determine the one or more second reference signals as the RLM-RSs for the first cell.

In an example, the total number of the one or more second reference signals are larger than the supported/allowed number of RLM-RSs, the wireless device may determine one or more third reference signals based on active TCI states of the one or more first CORESETs first. The wireless device may suppress any duplicate reference signals (e.g., consider as a single reference signal for duplicate reference signals) if any from the one or more third reference signals. After the suppression, when the number of reference signals is larger than the supported/allowed number of RLM-RSs (e.g., K), the wireless device may select the supported/allowed number of RLM-RSs from the reference signals, for example, based on procedure shown in FIG. 17. After the suppression, when the number of reference signals (e.g., M) is smaller than the supported/allowed number of RLM-RSs, the wireless device may select one or more fourth reference signals based on active TCI states of the one or more second CORESETs, wherein a number of selected reference signals may be a margin (e.g., K-M). The wireless device may select up to (K-M) reference signals based on the active TCI states of the one or more second CORESETs for example based on a procedure shown in FIG. 17. When K=M, the wireless device may complete the determination.

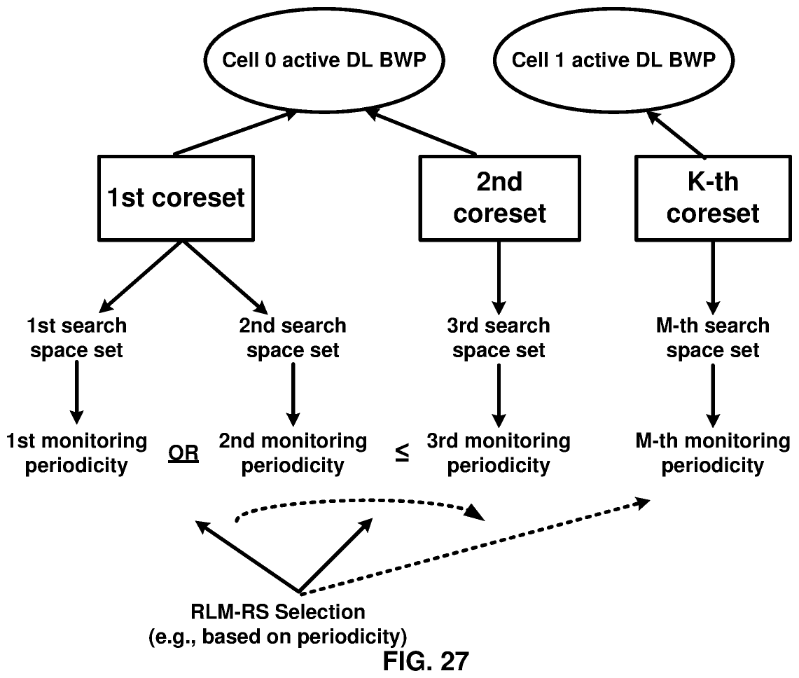

FIG. 27 illustrates an example of the embodiment. In some examples, when a total number of both the one or more first CORESETs and the one or more second CORESETs is larger than a supported/allowed number of RLM-RSs (K), the wireless device may determine one or more first reference signals based on active TCI states of the one or more first CORESETs first. The wireless device may suppress any duplicate reference signals if any from the one or more first reference signals. After the suppression, when the number of reference signals is larger than the supported/allowed number of RLM-RSs (e.g., K), the wireless device may select the supported/allowed number of RLM-RSs from the reference signals, for example, based on procedure shown in FIG. 17. After the suppression, when the number of reference signals (e.g., M) is smaller than the supported/allowed number of RLM-RSs, the wireless device may select one or more second reference signals based on active TCI states of the one or more second CORESETs, wherein a number of selected reference signals may be a margin/remainder (e.g., K-M). The wireless device may select up to (K-M) reference signals based on the active TCI states of the one or more second CORESETs for example based on a procedure shown in FIG. 17. When K=M, the wireless device may complete the determination.

FIG. 27 illustrates an example of a wireless device that may or may not select a reference signal of the k-th coreset of the second cell (e.g., cell 1) based on a number of reference signals of the first coreset and the second coreset of the first cell and an allowed number of RLM-RSs (e.g., K).

In an example, the total number of the one or more second reference signals are larger than the supported/allowed number of RLM-RSs (K) and/or when a total number of both the one or more first CORESETs and the one or more second CORESETs is larger than a supported/allowed number of RLM-RSs (K), the wireless device may select up to K reference signals from the one or more second reference signals. The wireless device may list the one or more first CORESETs and the one or more second CORESETs based on a shortest monitoring periodicity associated with each CORESET (e.g., a search space monitoring periodicity configured for the each CORESET). The wireless device may select a reference signal of an active TCI state of a CORESET from the list sequentially until a number of unique reference signals becomes K. When the first cell and the second cell are configured with a same numerology, a monitoring periodicity may be determined based on a unit of a slot or a unit of an OFDM symbol. When the first cell and the second cell are configured with different numerology, a monitoring periodicity may be determined based on an absolute time such as milli-seconds, seconds and micro-seconds. When the first cell and the second cell are configured with different numerology, a monitoring periodicity may be determined based on a unit of a slot based on a cell with larger (or smaller) subcarrier spacing.

FIG. 27 illustrates an example of an embodiment. In the example, the wireless device may support up to K=2 RLM-RSs. The wireless device is configured with a first CORESET (first coreset) and a second CORESET (second coreset) of a first cell (Cell 0). The wireless device is configured with a third CORESET (K-th coreset) of a second cell (Cell 1). The wireless device may determine up to K RLM-RSs from one or more first CORESETs of the first cell first. The wireless device may determine, when the selected/determined RLM-RSs is less than K, additional RLM-RSs from one or more second CORESETs of the second cell. For example, in FIG. 27, the wireless device may select a first RS associated with the first coreset and a second RS associated with the second coreset based on a monitoring periodicity of a coreset (e.g., a second search space has shorter monitoring periodicity than a third search space). When the first RS and the second RS is same, the wireless device may further select a RS associated with a TCI state of the K-th coreset of the second cell. When the first RS and the second RS is different, the wireless device may complete the determination. The wireless device may or may not select a RS from the second cell depending on a number of reference signals of active TCI states of the one or more first CORESETs of the first cell.

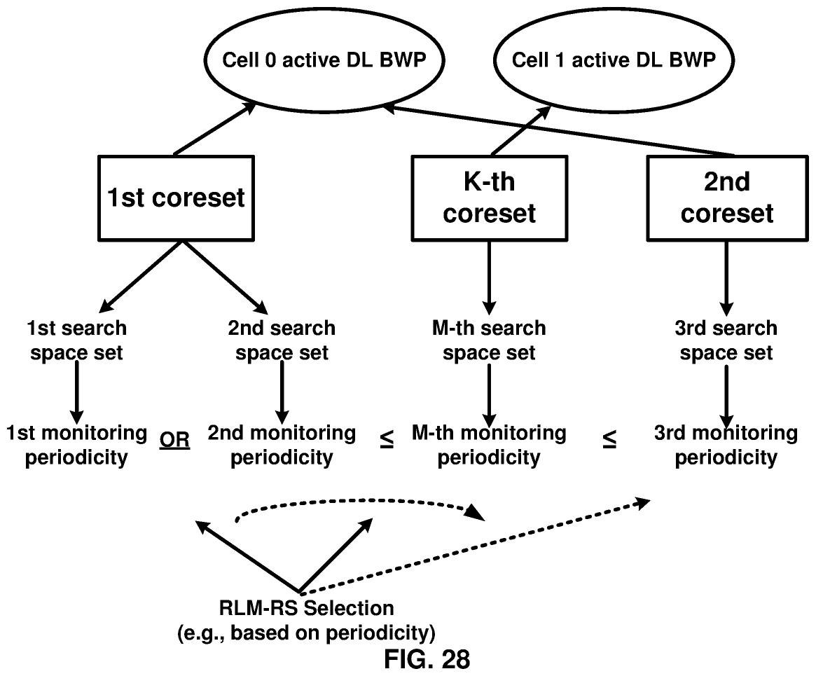

FIG. 28 illustrates an example of an embodiment. In the example, the wireless device may support up to K=2 RLM-RSs. The wireless device is configured with a first CORESET (first coreset) and a second CORESET (second coreset) of a first cell (Cell 0). The wireless device is configured with a third CORESET (K-th coreset) of a second cell (Cell 1). The wireless device may determine up to K RLM-RSs from one of more first CORESETs of the first cell and one or more second CORESETs of the second cell based on ordered list according to a monitoring periodicity of each CORESET. For example, in FIG. 28, a second monitoring periodicity is smallest, a M-th monitoring periodicity is a middle one, and a third monitoring periodicity is largest.

In case, a first monitoring periodicity of a first coreset is same as a M-th monitoring periodicity of a K-th coreset, the wireless device may select a RS based on a lower cell index and/or based on a CORESET associated with the first cell and/or based on a search space index. One or more combinations may be supported (e.g., first based on a search space index and a cell index next). For example, the wireless device may select the first coreset first than the K-th coreset based on the first coreset is associated with the first cell. For example, the wireless device may select the first coreset first than the K-th coreset based on the first cell has lower cell index than the second cell. For example, the wireless device may select the first coreset first than the K-th coreset based on the first coreset has a lower index than the K-th coreset. When the second monitoring periodicity is same as the third monitoring periodicity, the wireless device may select a RS based on a corset index and/or a search space index. For example, the wireless device may select the first RS of the first coreset based on the first coreset has a smaller index than the third coreset. For example, the wireless device may select the first RS of the first coreset based on the second search space has a smaller index than the third search space. In case, a search space index is used, a search space with a shortest monitoring periodicity associated with a CORESET is used.

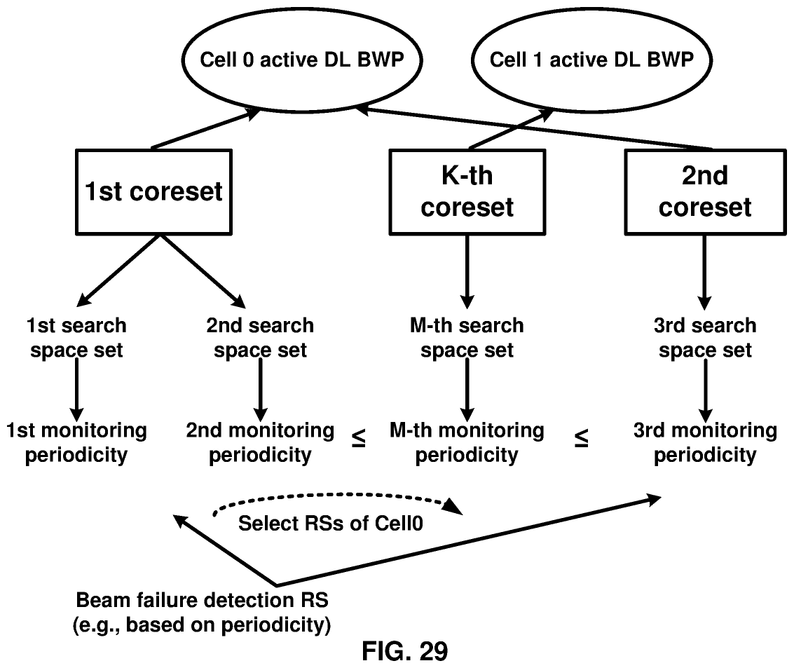

FIG. 29 illustrates an example of selecting one or more reference signals for a link quality monitoring (e.g., detectionResources for a beam failure). For example, the wireless device may have selected a first RS associated with a first coreset of the first cell and a second RS associated with a K-th coreset of the second cell as K=2 RLM-RSs. In the example, the wireless device may support up to two RSs for the link quality monitoring. The wireless device may select two RSs based on one or more first CORESETs of the first cell only. The wireless device may select the first RS associated with the first coreset and a third RS associated with a third coreset of the first cell.

In an example, the wireless device may not select a RS for the link quality monitoring, wherein one or more RLM-RSs may not comprise the RS. For example, in FIG. 29, the wireless device may not select the third RS associated with the third coreset for the link quality monitoring as the third RS is not belonging to the RLM-RSs of the first cell. In such case, the wireless device may select a single RS (e.g., the first RS associated with the first coreset) for the link quality monitoring. The wireless device may select one or more reference signals of one or more first CORESETs associated with a first cell, for a link quality measurement for the first cell, wherein the one or more reference signals are belonging to one or more RLM-RSs of the first cell (if available).

In an example, a wireless device may receive configuration parameters of PDCCHs scheduling a primary cell. The configuration parameters may indicate a first coreset of the primary cell and a second coreset of a secondary cell. The first coreset may be associated with a first reference signal and may be used for a self-carrier scheduling of the primary cell. The second coreset may be associated with a second reference signal and may be used for a cross-carrier scheduling for the primary cell.

The wireless device may select, as a link quality monitoring reference signal, the first reference signal from the first reference signal and the second reference signal. The wireless device may select the first reference signal based on the primary cell comprising the first coreset. The wireless device may not monitor the second reference signal for the link quality monitoring for the primary cell. The wireless device may initiate a link recovery procedure based on measurement of the link quality monitoring reference signal.

For example, the configuration parameters may indicate a third coreset (e.g., 2^{nd} coreset in FIG. 29) that is associated with a third reference signal and may be used for a self-carrier scheduling of the primary cell. The wireless device may determine the third reference signal as a second link quality monitoring reference signal for the primary cell. The wireless device may monitor the third coresets in response to the cross-carrier scheduling being disabled. The wireless device may stop monitoring the third coresets in response to the cross-carrier scheduling being enabled. The wireless device may determine a reference signal (RS) of a coreset based on a TCI state of the coreset. The TCI state may comprise the reference signal.

The wireless device may determine an RS included in the TCI state when the TCI state comprises a single RS as the CSI-RS. The wireless device may determine an RS included in the TCI state when the TCI state comprises two RSs, wherein the RS is configured with QCL-TypeD (e.g., a spatial domain related quasi-collocated property), as the CSI-RS. The wireless device may use the CSI-RS associated with the CORESET as the reference signal.

Embodiments may allow less occurrence of a radio link failure by performing a radio link monitoring over one or more first reference signals of a first cell and one or more second reference signals of a second cell. Even if the one or more first reference signals may result in low qualities, the base station may be able to communicate with a wireless device via one or more second CORESETs of the second cell based on cross-carrier scheduling.

In an example, a wireless device may be configured with cross-carrier scheduling of a first cell, wherein a second cell is a scheduling cell for the first cell. The wireless device may monitor one or more first CORESETs of the first cell and one or more second CORESETs of the second cell, for monitoring DCIs comprising resource assignments for the first cell. In response to being configured as the scheduling cell for the first cell, a base station may configure a RadioLinkMonitoringConfig or configuration parameters of one or more RLM-RSs for the second cell. For example, the second cell is a secondary cell. The RadioLinkMonitoringConfig or the configuration parameters may be configured separately from one or more reference signals for a link quality monitoring (e.g., one or more beam reference signals). The configuration parameters may comprise one or more detectionResources for the RLM measurement, where a detectionResource may be a CSI-RS or an SSB of the second cell. The wireless device may be configured with a first counter (e.g., N310 counter) to start a first timer (e.g., T310 timer) in response to receiving consecutive out-of-sync events based on the measurements of the one or more RLM-RSs of the second cell. The wireless device may be configured with a second counter (e.g., N311 counter) to stop the first timer in response to receiving consecutive in-sync events. The wireless device may use a same set of values of a first counter, a first timer and a second counter, configured/indicated for the first cell, for performing the RLM for the second cell, wherein the wireless device may not receive parameters of the first counter, the first timer and the second counter for the second cell.

In response to being configured with the one or more RLM-RSs for the second cell, the wireless device may perform measurements of radio link qualities based on the one or more RLM-RSs. The wireless device may operate a first RLM procedure for the second cell additionally to a first RLM procedure for the first cell. The wireless device may run independent timers/counters between the first RLM procedure and the second RLM procedure. When the wireless device is not provided with the one or more RLM-RSs of the second cell via an explicit RRC signaling, the wireless device may determine the one or more RLM-RSs of the second cell based on the one or more second CORESETs. The wireless device may have third CORESETs of the second cell, where the wireless device may not monitor DCIs comprising resource assignments for the first cell. The wireless device may not determine the one or more RLM-RSs based on the one or more third CORESETs of the second cell. The wireless device may determine RLM-RSs based on the one or more second CORESETs, where the wireless device may monitor DCIs comprising resource assignments for the first cell.

In an example, the wireless device may be configured with one or more first RLM-RSs for the first cell. The wireless device may determine the one or more first RLM-RSs based on the one or more first CORESETs if the one or more first RLM-RSs are not provided via explicit RRC signaling. In response to detecting a first RLF based on the one or more first RLM-RSs of the first cell for the first cell, the wireless device may initiate a RRC reestablishment procedure, wherein the first cell is a primary cell of a master cell group or a primary cell (e.g., PCell). For example, when the first cell is a PSCell, the wireless device may inform the RLF to a network. In response to detecting the first RLF, the wireless device may perform one or more procedures of an RLF event for a cell, wherein the cell is not configured with cross-carrier scheduling (e.g., existing/legacy procedures). For the RLF event of the first cell, the wireless device may behave in a same manner in a first case wherein the wireless device is configured with cross-carrier scheduling of the first cell and a second case wherein the wireless device is configured with self-carrier scheduling of the first cell.

In response to detecting a second RLF based on the one or more RLM-RSs of the second cell for the second cell, the wireless device may inform the second RLF to the base station. For example, the wireless device may inform the second RLF via a dedicated scheduling request (SR) resource based on a SR configuration. The base station may configure the SR configuration, dedicated to the indication of the second RLF, wherein the SR configuration may comprise a plurality of dedicated SR resources. The wireless device may select a dedicated SR resource from the plurality of the dedicated SR resources and transmits an uplink signal (e.g., PUCCH) comprising the indication of the second RLF via the selected dedicated resource. In response to receiving the indication of the second RLF, the base station may perform one or more followings. For example, the base station may reconfigure cross-carrier scheduling for the first cell. For example, the base station may change a scheduling cell to a third cell from the second cell. For example, the base station may deactivate the cross-carrier scheduling. For example, the base station may configure one or more third CORESETs of the second cell for monitoring DCIs comprising resource assignments for the first cell. In response to deactivated cross-carrier scheduling by the second cell, the wireless device may stop performing the second RLM procedure on the second cell. In response to switching to the third cell as the scheduling cell, the wireless device may start performing a third RLM procedure on the third cell. The base station may configure configuration parameters to enable the third RLM procedure for the third cell.

In an example, the wireless device may transmit a beam failure recovery request in response to the second RLF. The wireless device may consider the second RLF as a beam failure detection. The wireless device may start the beam failure recovery procedure for the second cell. In response to receiving the beam failure recovery request, the base station may perform one or more followings. For example, the base station may reconfigure cross-carrier scheduling for the first cell. For example, the base station may change a scheduling cell to a third cell from the second cell. For example, the base station may deactivate the cross-carrier scheduling. For example, the base station may configure one or more third CORESETs of the second cell for monitoring DCIs comprising resource assignments for the first cell. For example, the base station may perform a beam recovery process to update candidate beams for the one or more second CORESETs of the second cell.

In an example, the wireless device may transmit a cross-carrier scheduling deactivation request to the base station in response to the second RLF and/or the beam failure of the second cell. For example, the wireless device may transmit the request via one or more MAC CEs and/or UCIs, carried in a PUSCH. The wireless device may trigger a SR to receive an uplink grant to schedule the PUSCH. For example, a MAC CE of the request may comprise a scheduling cell index and a scheduled cell index. For example, the scheduling cell index indicates the second cell and the scheduled cell index indicates the first cell. In response to receiving the MAC CE, the base station may deactivate cross-carrier scheduling and/or may reconfigure a scheduling cell to a third cell. The MAC CE may comprise a candidate cell index, wherein the wireless device may recommend the candidate cell is configured as a new scheduling cell for the first cell.

In an example, a wireless device may be configured with cross-carrier scheduling for a first cell, wherein a second cell is a scheduling cell. The wireless device may transmit the cross-carrier scheduling deactivation request to the base station in response to one or more conditions are being met. For example, the one or more conditions may comprise a beam failure declaration/detection of the second cell. For example, the one or more conditions may comprise a case where the wireless device may recommend the second cell becomes a dormant cell (or transition to a dormant state, or transition to a dormant BWP of the second cell). For example, the one or more conditions may comprise a case where the wireless device may recommend a DRX configuration for the second cell. For example, the one or more conditions may comprise a case where the wireless device may recommend to deactivate the second cell and/or deconfigure the second cell. For example, the one or more conditions may comprise a case where the wireless device may deactivate the second cell based on sCellDeactivationTimer. For example, the one or more conditions may comprise a case where the wireless device may recommend switching to one or more BWPs, wherein the one or more BWPs may not be configured with cross-carrier scheduling for the first cell.

In response to receiving a MAC CE indicating deactivation of the second cell, the wireless device may deactivate cross-carrier scheduling by the second cell. In response to receiving a MAC CE and/or a DCI indicating transition the second cell to a dormant state, the wireless device may deactivate/suspend cross-carrier scheduling by the second cell. In case of the suspension, the wireless device may resume cross-carrier scheduling in response to receiving a command/timer transitioning the second cell to a non-dormant state. For example, in case of a beam failure detection of the second cell, the wireless device may suspend cross-carrier scheduling between a first time when the wireless device declares/detects the beam failure and a second time when the wireless device completes a beam failure recovery procedure for the second cell.

In an example, a wireless device may recommend whether to configure cross-carrier scheduling for a first cell. The wireless device may indicate a candidate cell for a scheduling cell for the first cell along with the recommendation and/or in response to the recommendation. The wireless device may recommend one or more BWPs of the candidate cell for configuring the cross-carrier scheduling. The wireless device may recommend a BWP of the candidate cell, wherein the one or more BWPs may not comprise the BWP, for not configuring the cross-carrier scheduling. For example, the BWP may be a default BWP of the candidate cell. For example, the BWP may be a dormant BWP of the candidate cell. In an example, the wireless device may assume that cross-carrier scheduling is not configured for a dormant BWP and/or a default BWP of a cell. For example, the wireless device may deactivate/suspend cross-carrier scheduling in response to switching to a default BWP of the second cell as an active BWP. For example, the wireless device may deactivate/suspend cross-carrier scheduling in response to switching to a dormant BWP of the second cell as an active BWP. For example, the wireless device may deactivate/suspend cross-carrier scheduling in response to switching to a first BWP of the second cell as an active BWP, wherein the first BWP is not configured to monitor a non-fallback DCI format.

In an example, the wireless device may recommend deactivating the second cell, a scheduling cell for the first cell. In response to receiving the recommendation, the base station may deactivate cross-carrier scheduling and/or reconfigure a scheduling cell for the first cell. In an example, the wireless device may not be allowed to recommend deactivating the second cell or transitioning the second cell to a dormant state. In an example, the wireless device may stop/suspend/halt sCellDeactivationTimer in response to configured/activated with cross-carrier scheduling for the first cell by the second cell, if the sCellDeactivationTimer is running. In an example, the wireless device may exclude the second cell from a group of a power saving signal in response to configured/activated with cross-carrier scheduling for the first cell by the second cell. For example, one or more DCIs comprising transitioning between a dormant and a non-dormant state for one or more cells may not indicate transitioning the second cell to the dormant state. The wireless device may receive an RRC configuration of the group of the power saving signal comprising the second cell. The wireless device may not apply the transition indication to the second cell regardless of the RRC configuration of the group.

For example, the transition indication may be transmitted via a DCI based on a non-fallback DCI format (e.g., a DCI format 1_1). For example, the DCI may comprise a bitmap, where each bit of the bitmap may correspond to each cell group of one or more cell groups comprising the cell group.

In an example, a wireless device may be configured/indicated with a first minimum scheduling offset for a first BWP of a first cell, wherein the first BWP is an active BWP of the first cell. The wireless device may be configured/indicated with a second minimum scheduling offset for a second BWP of a second cell, wherein the second BWP is an active BWP of the second cell. The wireless device may apply a larger (or smaller) value between the first minimum scheduling offset and the second scheduling offset for receiving/monitoring DCIs comprising resource assignments for the first cell via one or more second CORESETs of the second cell based on cross-carrier scheduling. The wireless device may apply the first minimum scheduling offset for receiving/monitoring the DCIs.

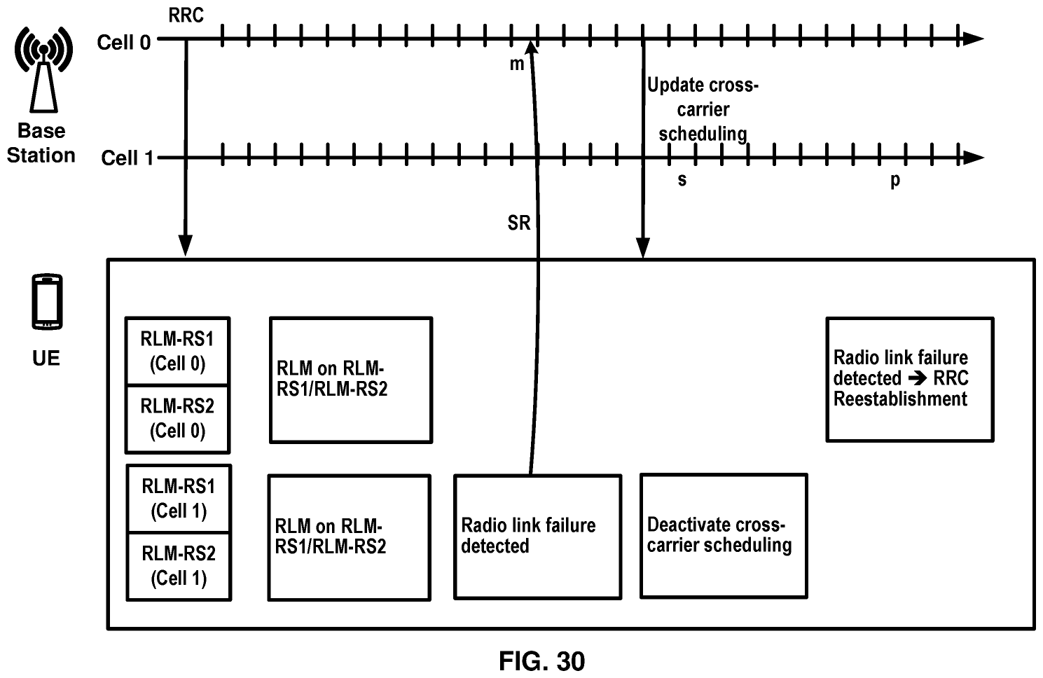

FIG. 30 illustrates an example of additional RLM on a second cell. The base station configures a first RLM-RS and a second RLM-RS for the first cell (Cell 0). The base station configures a third RLM-RS (RLM-RS1) and a fourth RLM-RS (RLM-RS2) for the second cell (Cell 1). The wireless device may perform a first RLM based on the first RLM-RS and the second RLM-RS for the first cell. The wireless device may perform a second RLM based on the third RLM-RS and the fourth RLM-RS for the second cell. The wireless device may perform the first RLM and the second RLM independently. The wireless device may detect/declare a second radio link failure (RLF) based on the second RLM of the third RLM-RS and the fourth RLM-RS. The wireless device may transmit an indication of the second RLF via a SR resource at a time m. The SR resource may be selected from a plurality of dedicated SR resources for indicating an RLF of the second cell or an RLF of a scheduling cell for the first cell when cross-carrier scheduling is configured/activated. In response to the indication of the second RLF, the base station may reconfigure configuration parameters of cross-carrier scheduling (e.g., reconfigure a scheduling cell to a third cell) and/or deactivate cross-carrier scheduling by the second cell. The wireless device may, in response to the second RLF, deactivate cross-carrier scheduling by the second cell. The wireless device may not monitor DCIs comprising resource assignments for the first cell via one or more search spaces of the second cell in response to the deactivating cross-carrier scheduling.

The wireless device may detect a first RLF based on the first RLM-RS and the second RLM-RS for the first cell. In response to the first RLF, the wireless device may perform a procedure of an RRC reestablishment, an RRC setup and/or indication of the first RLF in case the first cell is a primary cell of a secondary cell group (e.g., SPCell). The wireless device may determine a candidate cell to perform the RRC reestablishment. In response to a failure of identifying the candidate cell, the wireless device may transition to a RRC IDLE state.

In an example, a radio link failure of a downlink carrier of a first cell may not indicate a potential radio link failure of an uplink carrier of the first cell in some cases. For example, a base station may configure a supplemental uplink (SUL) carrier for a first cell in addition to a non-supplemental uplink (e.g., a regular UL carrier or a paired UL carrier). The base station may configure a plurality of PUCCH resources on the SUL carrier, wherein the plurality of PUCCH resources may comprise a plurality of SR resources. The base station may configure a plurality of PRACH resources on the SUL carrier. For example, a wireless device may not provide a beam correspondence between the downlink carrier of the first cell and the uplink carrier of the first cell. For example, the uplink carrier is the SUL carrier. For example, the wireless device may be equipped with a plurality of uplink panels, different from downlink panel(s). For example, the wireless device may not support the beam correspondence by UE capability.

In such cases, the RLF of the downlink carrier of the first cell may not lead to unavailable uplink resources such as the plurality of PUCCH resources. The wireless device may have available uplink resources in spite of the RLF of the downlink carrier. To expedite a recovery process of the RLF, the wireless device may indicate the RLF via the available uplink resources. For example, the wireless device may indicate the RLF via a SR resource of the plurality of SR resources configured on the SUL carrier of the first cell. For example, the wireless device may indicate the RLF via an uplink resource (e.g., a PUSCH) of the uplink carrier of the first cell. For example, the wireless device may indicate the RLF via a PUCCH resource configured to a PUCCH cell of a cell group, different from the first cell, wherein the PUCCH cell and the first belong to the cell group.

In an example, a base station may configure a dedicated SR configuration, comprising a plurality of SR resources, for indicating an RLF of the first cell. The wireless device may determine whether there is the dedicated SR configuration is configured for a cell group, wherein the first cell belongs to. The base station may configure the dedicated SR configuration on a SUL carrier of the first cell, a UL carrier of the first cell, a SUL carrier of a PUCCH cell, and/or a UL carrier of the PUCCH cell. The PUCCH cell and the first cell may belong to the same cell group. Based on the determining, the wireless device may select a SR resource based on the dedicated SR configuration. When the wireless device selects a valid SR resource, the wireless device may transmit the SR indicating the RLF of the first cell. When the wireless device may not have a valid SR resource, the wireless device may not indicate the RLF of the first cell. In response to no valid SR resource for the indicating the RLF, the wireless device may perform a RRC reestablishment and/or a RRC setup procedure. The wireless device may not enable indication of an RLF of the first cell in response to not being configured with the dedicated SR configuration or in response to not identifying a valid SR based on the dedicated SR configuration.

In response to receiving the indication of the RLF of the first cell, the base station may transmit an intra-gNB or an intra-cell handover command (e.g., change the second cell as the primary cell of the cell group) or an inter-gNB or an inter-cell handover command (e.g., switch to a second base station, switch to a third cell for the primary cell) or a RRC setup command or a RRC reconfiguration command. Based on the indication, the base station may perform a necessary procedure to recover a primary cell for the wireless device.

In an example, a wireless device may transmit an indication of an RLF of a first cell in response to one or more conditions are being met. For example, the one or more conditions may comprise a configuration of a dedicated SR configuration for indicating the RLF for the first cell. The dedicated SR configuration may configure a plurality of SR resources in an uplink carrier of the first cell, an SUL carrier of the first cell, an uplink carrier of a PUCCH cell in a same cell group, and/or an SUL carrier of the PUCCH cell. For example, the one or more conditions may comprise a case wherein the wireless device is configured with cross-carrier scheduling for the first cell, wherein a second cell is a scheduling cell for the first cell. For example, the one or more conditions may comprise a case wherein the wireless device may not detect a beam failure for the second cell and/or the second cell is not under a beam failure recovery procedure. For example, the one or more conditions may comprise a case wherein link qualities of active TCIs of one or more second CORESETs of the second cell, wherein the wireless device may monitor DCIs comprising resource assignments for the first cell via the one or more second CORESETs, are better than a threshold (e.g., Qin). For example, the one or more conditions may comprise a case where the wireless device is configured with a SUL carrier for the first cell, wherein a plurality of PUCCH resources are configured for the SUL carrier. For example, the one or more conditions may comprise a case where the wireless device may not provide a beam correspondence between a downlink carrier of the first cell and an uplink carrier of the first cell.

Embodiments may allow dynamic adaptation of a scheduling cell for cross carrier scheduling of a primary cell. The base station may be able to quickly change/adapt the scheduling cell based on a second RLM on the configured scheduling cell.

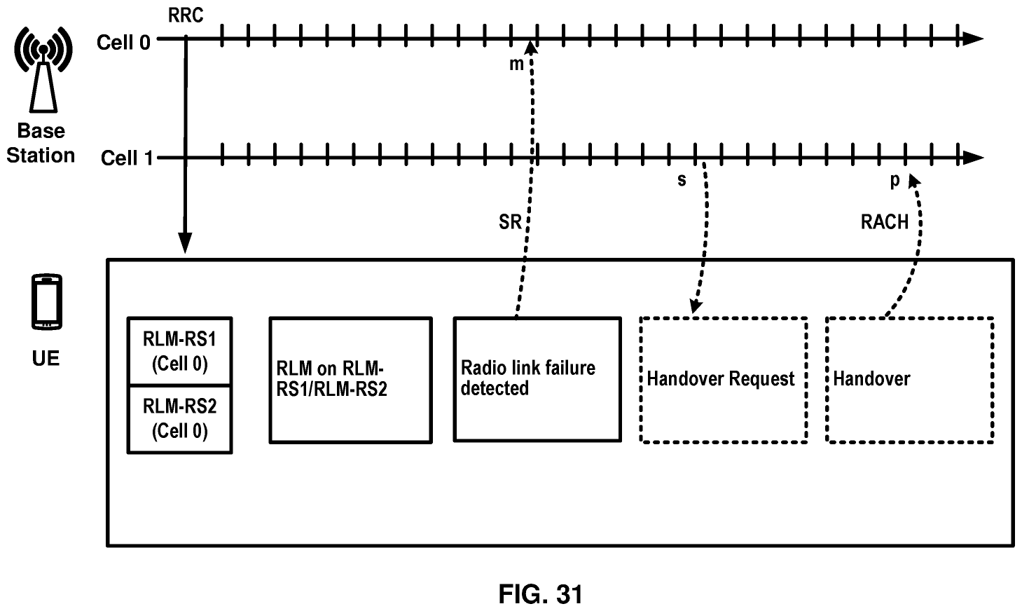

FIG. 31 illustrates an example of an embodiment. The base station configures a first RLM-RS (RLM-RS1) and a second RLM-RS (RLM-RS2) of a first cell for the first cell (Cell 0). The wireless device may perform a RLM for the first cell based on the first RLM-RS and the second RLM-RS of the first cell. The wireless device may declare/detect a RLF based on the first RLM-Rs and the second RLM-RS for the first cell. The wireless device may transmit a SR in response to one or more conditions being met. For example, the wireless device may transmit the SR wherein the wireless device is configured with a dedicated SR configuration for indicating an RLF of the first cell. In response to receiving the indication via the SR transmission, the base station may request a handover command to a second cell (Cell 1). The wireless device may perform the handover command and may switch to the second cell as a primary cell. The wireless device may transmit a preamble in response to the handover command.

In an example, the wireless device may transmit an RLF of a primary cell of a master cell group in response to one or more conditions are being met. For example, the one or more conditions may comprise a case wherein the wireless device is configured with a dedicated SR configuration on a uplink carrier of a cell of the master cell group, wherein the dedicated SR configuration is configured for indicating the RLF of the primary cell. For example, the one or more conditions may comprise a case wherein the primary cell is configured with cross-carrier scheduling, wherein a second cell is a scheduling cell for the primary cell. The second cell may have a valid link (e.g., not under a beam failure recovery procedure or have declared a beam failure). For example, the one or more conditions may comprise a case wherein a base station may configure enabling the indication via one or more RRC messages. For example, the one or more conditions may comprise a case where the wireless device may have at least one activated secondary cell with valid uplink resources (e.g., uplink resources with active beams/spatial domain filters).

In an example, a wireless device may transmit an indication of an RLF of a primary cell of a master cell group via an RRC signaling and/or a MAC CE and/or a UCI (e.g., piggybacking on a PUSCH). The wireless device may receive an uplink grant scheduling a PUSCH in a activated serving cell. The wireless device may transmit the indication of the RLF of the primary cell via the PUSCH. The wireless device may transmit a candidate cell index along with the indication of the RLF of the primary cell, wherein the wireless device may recommend the candidate cell as a new primary cell of the master cell group. In response to receiving the candidate cell index, the base station may transition the candidate cell as the new primary cell (e.g., handover). The wireless device may recommend a secondary cell from one or more activated secondary cells of the master cell group as the candidate cell. The candidate cell index may be in a range of [0 . . . 31] or [0 . . . 7] depending on a number of configured secondary cells for the master cell group. In an example, the wireless device may transmit a candidate cell ID along with the indication of the RLF of the primary cell. The wireless device may identify a candidate cell based on radio resource management (RRM) measurements. The base station may transmit a handover command to the candidate cell based on the information. The candidate cell ID may be selected based on RRM measurements regardless of activated serving cells.

In existing technologies, a wireless device may not indicate an RLF of a primary cell, wherein the primary cell belongs to a master cell group. The wireless device may not be able to transmit an uplink signal comprising the indication without valid uplink resources. In recent technology enhancements, there are scenarios where a radio link quality of a downlink carrier of a cell may be different from a radio link quality of an uplink carrier of the cell. For example, a base station may configure a supplemental uplink carrier for the cell, wherein the radio link quality of the supplemental uplink may be different from the downlink carrier. For example, the wireless device may have different characteristics/channel conditions based on a plurality of beams between downlink and uplink. In such cases, an RLF of the downlink carrier may not indicate invalid uplink resources. Enhancements to expedite a recovery of the RLF may be considered.

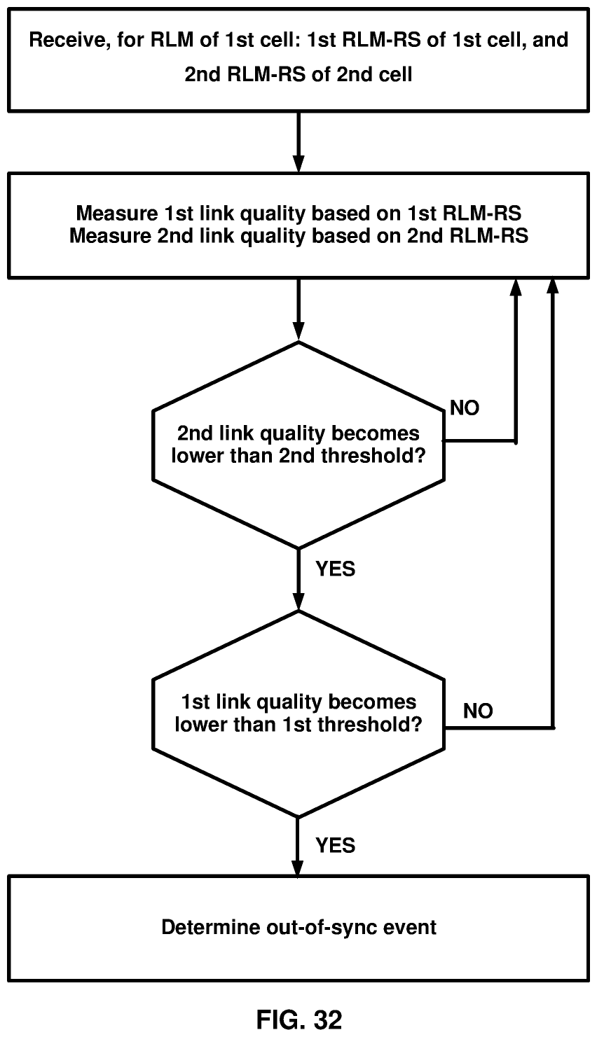

FIG. 32 illustrates an example flow diagram. A wireless device may receive one or more radio resource control messages indicating a first RLM-RS, wherein the first RLM-RS is a reference signal of a first cell and a second RLM-RS, wherein the second RLM-RS is a reference signal of a second cell. The wireless device may receive the one or more control messages indicating that the first cell is configured with cross-carrier scheduling, wherein the second cell is configured as a scheduling cell for the first cell. The wireless device, based on the configuration, may measure a first link quality based on the first RLM-RS. The wireless device may measure a second link quality of the second RLM-RS. The wireless device may determine whether the second link quality becomes lower than a second threshold (e.g., a second Qout). The wireless device may also determine the first link quality becomes lower than a first threshold (e.g., a first Qout). In response to both link qualities becoming lower than respective threshold, the wireless device may determine an out-of-sync event. The wireless device may determine/declare a radio link failure of the first cell in response to a number of consecutive out-of-sync events and/or an expiry of a timer (e.g., N310).

Embodiments allow faster recovery from a radio link failure by indicating a RLF of a primary cell to a base station as quickly as possible. Embodiments may reduce service interruption time from the radio link failure.

In an example, a base station may configure a first threshold for out-of-sync determination for one or more first RLM-RSs of a first cell. The base station may configure a second threshold for out-of-sync determination for one or more second RLM-RSs of a second cell. A wireless device may use the one or more first RLM-RSs and the one or more second RLM-RSs for a RLM of the first cell. Similarly, the base station may configure a third threshold for in-sync determination for the one or more first RLM-RSs. The base station may configure a fourth threshold for in-sync determination for the one or more second RLM-RSs. In an example, a first threshold for out-of-sync determination and a second threshold for in-sync determination may be configured for a RLM-RS.

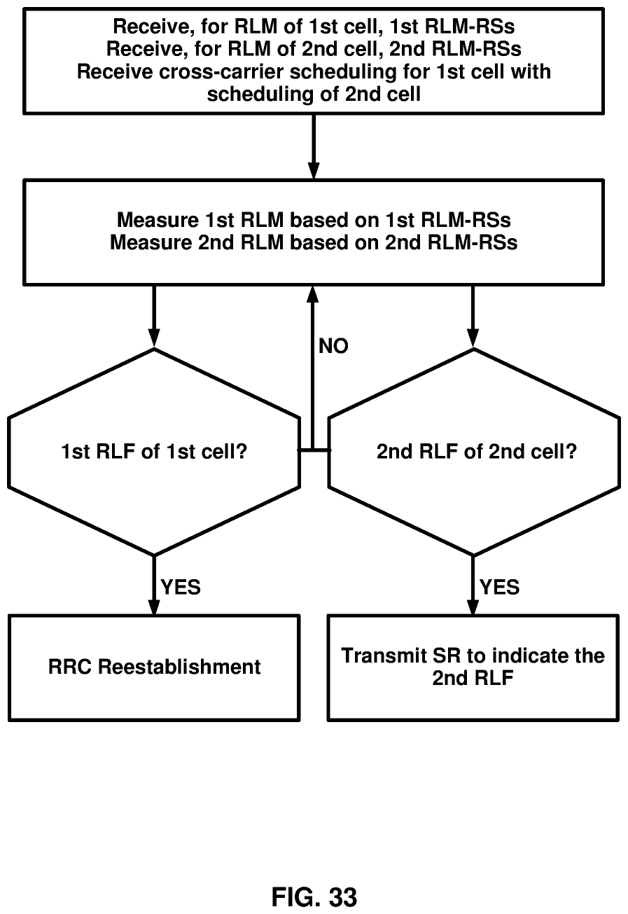

FIG. 33 illustrates a flow diagram of an embodiment. In an example, a wireless device may receive one or more radio resource control (RRC) messages indicating one or more first RLM-RSs, wherein the one or more first RLM-RSs are reference signal(s) of a first cell. The one or more RRC messages may further indicate one or more second RLM-RS, wherein the one or more second RLM-RSs are reference signal(s) of a second cell. The wireless device may receive the one or more control messages indicating that the first cell is configured with cross-carrier scheduling, wherein the second cell is configured as a scheduling cell for the first cell. The wireless device may perform a first RLM process for the first cell. The wireless device may measure radio link qualities based on the one or more first RLM-RSs for the first RLM process. The wireless device may perform a second RLM process for the second cell. The wireless device may measure radio link qualities based on the one or more second RLM-RSs for the second RLM process. Based on the link qualities of the one or more first RLM-RSs, the wireless device may declare/detect a first RLF of the first cell. In response to the first RLF of the first cell, the wireless device may attempt a RRC reestablishment process. Based on the link qualities of the one or more second RLM-RSs, the wireless device may declare/detect a second RLF of the second cell, for supporting cross-carrier scheduling of the first cell. In response to the second RLF of the first cell, the wireless device may indicate the second RLF to the base station via a SR transmission and/or an uplink transmission.

In an example, a wireless device may receive one or more radio resource control (RRC) messages. The one or more RRC messages may indicate a first reference signal of a first cell and a second reference signal of a second cell. The second cell may be configured as a scheduling cell for the first cell. The wireless device may measurement of the radio link monitoring for the first cell based on the first reference signal and the second reference signal. The wireless device may determine a radio link failure for the first cell based on the measurement. The wireless device may initiate a radio link failure recovery procedure in response to the determining the radio link failure.

In an example, a wireless device may receive one or more radio resource control (RRC) messages. The one or more RRC messages may comprise configuration parameters for a radio link monitoring for a first cell. The configuration parameters may indicate a first reference signal of the first cell and a second reference signal of a second cell. The second cell may be configured as a scheduling cell for the first cell. The wireless device may perform measurement of the radio link monitoring for the first cell based on the first reference signal and the second reference signal. The wireless device may determine a radio link failure for the first cell based on the measurement. The wireless device may initiate a radio link failure recovery procedure in response to the determining the radio link failure.

For example, the first reference signal is a reference signal configured for a first transmission configuration indicator (TCI) state of a first control resource set (coreset), wherein the wireless device monitors the first coreset of the first cell for receiving DCIs comprising resource assignment for the first cell. For example, the second reference signal is a reference signal configured for a second TCI state of a second coreset, wherein the wireless device monitors the second coreset of the second cell for receiving DCIs comprising resource assignment for the first cell.

For example, the wireless device may receive one or more second radio resource control (RRC) messages comprising parameters. The parameters may comprise a first index of the first reference signal of the first cell. The parameters may further comprise/indicate a cell index for the second reference signal, wherein the cell index indicates the second cell. The parameters may further comprise/indicate a second index of the second reference signal of the second cell, wherein the second index indicates a reference signal among one or more reference signals of the second cell.

For example, the wireless device may assess a radio link quality based on the first reference signal and the second reference signal. For example, the wireless device may determine an event of in-sync or out-of-sync based on the assessed radio link quality. For example, the wireless device may identify the out-of-sync in response to radio link qualities based on the first reference signal and the second reference signals become below than a threshold (e.g., Qout). For example, the wireless device may identify the out-of-sync in response to radio link qualities based on either the first reference signal or the second reference signals falling below than a threshold (e.g., Qout). The wireless device may detect the radio link failure based on the event of out-sync. For example, the wireless device may start a first timer (e.g., T310) in response to triggering a number of consecutive out-of-sync events. After an expiry of the first timer, the wireless device may declare the radio link failure.

For example, the wireless device may transmit a preamble in response to the initiating the radio link failure recovery procedure. For example, the wireless device may transmit an indication of the radio link failure to a base station, at least when the first cell is a special primary cell of a secondary cell group. For example, the wireless device may stop monitoring for a DCI via the second cell, wherein the DCI comprises a resource assignment for the first cell, in response to the initiating the radio link failure recovery procedure. For example, the wireless device may release the configuration parameters in response to the initiating the radio link failure recovery procedure.

In an example, a wireless device may receive one or more radio resource control (RRC) messages. The one or more RRC messages may comprise configuration parameters for a radio link monitoring for a first cell. The configuration parameters may indicate a first reference signal of a second cell. The second cell may be configured as a scheduling cell for the first cell. The configuration parameters may further indicate a second reference signal of the first cell or the second cell. The wireless device may perform measurement of the radio link monitoring for the first cell based on the first reference signal and the second reference signal. The wireless device may determine a radio link failure for the first cell based on the measurement. The wireless device may initiate a radio link failure recovery procedure in response to the determining the radio link failure.

For example, the first reference signal is a reference signal configured for a first TCI state of a first coreset, wherein the wireless device monitors the first coreset of the second cell for receiving DCIs comprising resource assignment for the first cell. For example, the second reference signal is a reference signal configured for a second TCI state of a second coreset, wherein the wireless device monitors the second coreset of the second cell for receiving DCIs comprising resource assignment for the first cell. For example, the second reference signal is a reference signal configured for a second TCI state of a second coreset, wherein the wireless device monitors the second coreset of the first cell for receiving DCIs comprising resource assignment for the first cell

In an example, a wireless device may receive one or more messages comprising configuration parameters for a first cell. The configuration parameters may indicate one or more first search spaces of the first cell, for monitoring first DCIs comprising resource assignments for the first cell based on self-carrier scheduling. The configuration parameters may further indicate one or more second search spaces of a second cell, for monitoring second DCIs comprising resource assignments for the first cell based on cross-carrier scheduling. The wireless device may determine one or more reference signals of a plurality of transmission configuration indicator (TCI) states associated with a plurality of control resource sets (coresets), wherein the plurality of coresets are configured for search spaces of the one or more first search spaces and the one or more second search spaces, wherein the search spaces are in ascending order based on a monitoring periodicity of each search space of the one or more first search spaces and the one or more second search space. The wireless device may perform measurements for a radio link monitoring for the first cell based on the one or more reference signals. The wireless device may detect a radio link failure for the first cell based on the measurement. The wireless device may initiate a radio link failure recovery procedure in response to the radio link failure.

In an example, a wireless device may receive one or more messages comprising configuration parameters for a first cell. The configuration parameters may indicate one or more first control resource sets (coresets) of the first cell, for monitoring first DCIs comprising resource assignments for the first cell based on self-carrier scheduling. The configuration parameters may further indicate one or more second coresets of a second cell, for monitoring second DCIs comprising resource assignments for the first cell based on cross-carrier scheduling. The wireless device may determine one or more first reference signals based on the one or more first coresets. The wireless device may determine a number of the one or more reference signals being smaller than a maximum number. The wireless device may determine one or more second reference signals based on the one or more second coresets when the number is smaller than the maximum number. The wireless device may perform measurements of a radio link monitoring for the first cell based on the one or more first reference signals and the one or more second reference signals. The wireless device may declare/detect a radio link failure for the first cell based on the measurement. The wireless device may initiate a radio link failure recovery procedure in response to the radio link failure.

For example, the wireless device may determine the one or more first reference signals based on one or more of first transmission configuration indicator (TCI) states associated with the one or more first coresets, wherein the one or more of first coresets are configured for one or more first search spaces, wherein the one or more first search spaces are in ascending order based on a monitoring periodicity of each search space of the one or more first search spaces. For example, the wireless device may determine the one or more second reference signals based on one or more of second transmission configuration indicator (TCI) states associated with the one or more second coresets, wherein the one or more of second coresets are configured for one or more second search spaces, wherein the one or more second search spaces are in ascending order based on a monitoring periodicity of each search space of the one or more second search spaces.

In an example, a wireless device may receive one or more messages comprising configuration parameters for a first cell. The configuration parameters may indicate one or more first search spaces of the first cell, for monitoring first DCIs comprising resource assignments for the first cell based on self-carrier scheduling. The configuration parameters may further indicate one or more second search spaces of a second cell, for monitoring second DCIs comprising resource assignments for the first cell based on cross-carrier scheduling. The wireless device may determine one or more reference signals of a one or more of transmission configuration indicator (TCI) states associated with a one or more control resource sets (coresets), wherein the one or more of coresets are configured for search spaces of the one or more first search spaces, wherein the search spaces are in ascending order based on a monitoring periodicity of each search space of the one or more first search spaces. The wireless device may determine a number of the one or more reference signals being smaller than a maximum number. Based on the determining, the wireless device may determine one or more second reference signals a one or more of second transmission configuration indicator (TCI) states associated with a one or more second control resource sets (coresets), wherein the one or more of second coresets are configured for search spaces of the one or more second search spaces, wherein the search spaces are in ascending order based on a monitoring periodicity of each search space of the one or more second search spaces. The wireless device may perform measurements of a radio link monitoring for the first cell based on the one or more first reference signals and the one or more second reference signals. The wireless device may declare/detect a radio link failure for the first cell based on the measurement. The wireless device may initiate a radio link failure recovery procedure in response to the radio link failure.

In an example, a wireless device may receive one or more messages comprising configuration parameters for a first cell. The configuration parameters may indicate scheduling request resources for indicating a radio link failure and one or more reference signals for measuring radio link qualities. The wireless device may measure the radio link qualities of the one or more reference signals. The wireless device may determine a radio link failure based on the measurements. In response to the radio link failure, the wireless device may transmit an uplink signal comprising an indication of the radio link failure via a resource of the scheduling request resources.

In an example, a wireless device may receive one or more messages comprising configuration parameters for a first cell. The configuration parameters may indicate scheduling request resources for indicating a radio link failure and one or more reference signals for measuring radio link qualities. The wireless device may measure the radio link qualities of the one or more reference signals. The wireless device may determine a radio link failure based on the measurements. The wireless device may determine a condition is satisfied. In response to the radio link failure and the condition being satisfied, the wireless device may transmit an uplink signal comprising an indication of the radio link failure via a resource of the scheduling request resources.

For example, the condition may comprise a scheduling cell for a primary cell is configured with valid reference signals, wherein the reference signals are configured for transmission configuration indicator (TCI) states of one or more control resource sets. The wireless device may monitor DCIs via the one or more control resource sets of the scheduling cell, wherein DCIs comprise resource assignments for the primary cell. For example, the condition may comprise the scheduling request resources are configured in a supplemental uplink of a primary cell. For example, the condition may comprise the wireless device does not support beam correspondence between downlink beams and uplink beams.

What is claimed:

1. A method comprising:
in response to a secondary cell cross-carrier scheduling a primary cell, determining, by a wireless device, one or more radio link monitoring reference signals based on:
one or more first control resource sets (coresets) of the primary cell; and
one or more second coresets of the secondary cell; and
measuring the radio link monitoring reference signals for radio link monitoring.

2. The method of claim 1, further comprising receiving configuration parameters of physical downlink control channels (PDCCHs) for scheduling the primary cell, the configuration parameters indicating:
the one or more first coresets of the primary cell; and
the one or more second coresets of the secondary cell cross-carrier scheduling the primary cell.

3. The method of claim 1, further comprising determining that the secondary cell cross-carrier scheduling the primary cell based on the secondary cell being activated.

4. The method of claim 1, further comprising determining one or more second radio link monitoring reference signals, of the one or more radio link monitoring reference signals, based on:
one or more first search spaces associated with the one or more first coresets of the primary cell; and
one or more first transmission configuration indicator (TCI) states of the one or more first coresets.

5. The method of claim 4, further comprising determining the one or more first TCI states based on at least one of:
one or more monitoring periodicities of the one or more first search spaces,
one or more first coreset indexes of the one or more first coresets, or
on one or more first search space indexes of the one or more first search spaces.

6. The method of claim 4, wherein the one or more radio link monitoring reference signals comprise one or more reference signals of the one or more first TCI states.

7. The method of claim 4, further comprising determining one or more second TCI states based on at least one of:
one or more second monitoring periodicities of the one or more second search spaces,
one or more second coreset indexes of the one or more second coresets, or
one or more second search space indexes of the one or more second search spaces.

8. The method of claim 1, wherein the determining the one or more radio link monitoring reference signals is further based on:
one or more first search spaces associated with the one or more first coresets of the primary cell;
one or more second search spaces associated with the one or more second coresets of the secondary cell; and
one or more TCI states of both the one or more first coresets and the one or more second coresets.

9. The method of claim 1, further comprising:
receiving second configuration parameters indicating a threshold for an out-of-sync event; and
determining the out-of-sync event of the radio link monitoring based on the threshold and the measuring the one or more radio link monitoring reference signals.

10. The method of claim 9, further comprising detecting a radio link failure based on the out-of-sync event, wherein the determining the out-of-sync event is based on signal quality, of each reference signal of the one or more radio link monitoring reference signals, being lower than the threshold.

11. A wireless device comprising:
one or more processors; and
memory storing instructions that, when executed by the one or more processors, cause the wireless device to:
in response to a secondary cell cross-carrier scheduling a primary cell, determine one or more radio link monitoring reference signals based on:
one or more first control resource sets (coresets) of the primary cell; and
one or more second coresets of the secondary cell; and
measure the radio link monitoring reference signals for radio link monitoring

12. The wireless device of claim 11, wherein the instructions, when executed by the one or more processors, further cause the wireless device to receive configuration parameters of physical downlink control channels (PDCCHs) for scheduling the primary cell, the configuration parameters indicating:
the one or more first coresets of the primary cell; and
the one or more second coresets of the secondary cell cross-carrier scheduling the primary cell.

13. The wireless device of claim 11, wherein the instructions, when executed by the one or more processors, further cause the wireless device to determine that the secondary cell cross-carrier scheduling the primary cell based on the secondary cell being activated.

14. The wireless device of claim 11, wherein the instructions, when executed by the one or more processors, further cause the wireless device to determine one or more second radio link monitoring reference signals, of the one or more radio link monitoring reference signals, based on:
one or more first search spaces associated with the one or more first coresets of the primary cell; and
one or more first transmission configuration indicator (TCI) states of the one or more first coresets.

15. The wireless device of claim 14, wherein the instructions, when executed by the one or more processors, further cause the wireless device to determine the one or more first TCI states based on at least one of:
one or more monitoring periodicities of the one or more first search spaces,
one or more first coreset indexes of the one or more first coresets, or
on one or more first search space indexes of the one or more first search spaces.

16. The wireless device of claim 14, wherein the one or more radio link monitoring reference signals comprise one or more reference signals of the one or more first TCI states.

17. The wireless device of claim 14, wherein the instructions, when executed by the one or more processors, further cause the wireless device to determine one or more second TCI states based on at least one of:
one or more second monitoring periodicities of the one or more second search spaces,
one or more second coreset indexes of the one or more second coresets, or
one or more second search space indexes of the one or more second search spaces.

18. The wireless device of claim 11, wherein the determining the one or more radio link monitoring reference signals is further based on:
one or more first search spaces associated with the one or more first coresets of the primary cell;
one or more second search spaces associated with the one or more second coresets of the secondary cell; and
one or more TCI states of both the one or more first coresets and the one or more second coresets.

19. The wireless device of claim 11, wherein the instructions, when executed by the one or more processors, further cause the wireless device to:
receive second configuration parameters indicating a threshold for an out-of-sync event; and
determine the out-of-sync event of the radio link monitoring based on the threshold and the measuring the one or more radio link monitoring reference signals.

20. A system comprising:
a base station comprising:
one or more first processors; and
first memory storing first instructions that, when executed by the one or more first processors, cause the base station to transmit configuration parameters of a primary cell and a secondary cell; and
a wireless device comprising:
one or more second processors; and
second memory storing second instructions that, when executed by the one or more second processors, cause the wireless device to:
receive the configuration parameters of the primary cell and the secondary cell
in response to the secondary cell cross-carrier scheduling the primary cell, determine radio link monitoring reference signals based on:
one or more first control resource sets (coresets) of the primary cell; and
one or more second coresets of the secondary cell; and
measure the radio link monitoring reference signals for radio link monitoring of the primary cell.
